(19) United States
(12) Patent Application Publication
(10) Pub. No.: US 2020/0367242 A1
(43) Pub. Date: Nov. 19, 2020

(54) METHOD FOR TRANSMITTING AND RECEIVING DOWNLINK CHANNEL AND REFERENCE SIGNAL IN COMMUNICATION SYSTEM

(71) Applicant: ELECTRONICS AND TELECOMMUNICATIONS RESEARCH INSTITUTE, Daejeon (KR)

(72) Inventors: Sung Hyun MOON, Daejeon (KR); Jung Hoon LEE, Daejeon (KR); Jun Hwan LEE, Seoul (KR); Min Hyun KIM, Busan (KR); Ji Hyung KIM, Daejeon (KR); Cheul Soon KIM, Daejeon (KR); Ju Ho PARK, Daejeon (KR)

(73) Assignee: ELECTRONICS AND TELECOMMUNICATIONS RESEARCH INSTITUTE, Daejeon (KR)

(21) Appl. No.: 16/605,975

(22) PCT Filed: Apr. 27, 2018
(86) PCT No.: PCT/KR2018/004924

§ 371 Date: Oct. 17, 2019

(30) Foreign Application Priority Data
Apr. 28, 2017 (KR) 10-2017-0055563
May 4, 2017 (KR) 10-2017-0057065
Jun. 16, 2017 (KR) 10-2017-0076913
Aug. 11, 2017 (KR) 10-2017-0102627
Mar. 16, 2018 (KR) 10-2018-0030962

(51) Int. Cl. H04W 72/04; H04L 5/00

(52) U.S. Cl. CPC H04W 72/0453; H04W 72/042; H04L 5/0048

(57) ABSTRACT

Disclosed is a method for transmitting and receiving a downlink channel and a reference signal in a communication system. A method for receiving a downlink signal performed by a terminal comprises the steps of: receiving, from a base station, a control DMRS for a downlink control channel in time-frequency resource region #1; performing demodulation and decoding operations on the downlink control channel in the time-frequency resource region #1 by using channel estimation information #1 on the basis of the control DMRS; and performing demodulation and decoding operations on a downlink data channel by using the channel estimation information #1 in a frequency band A in a time-frequency resource region #2 indicated by scheduling information obtained from the downlink control channel. Therefore, the performance of the communication system can be improved.

### TECHNICAL FIELD

The present invention relates to transmission and reception of a downlink channel in a communication system, and more particularly, to techniques for transmitting and receiving reference signals used for demodulating a downlink channel

### BACKGROUND ART

A communication system (e.g., a new radio (NR)) using a higher frequency band (e.g., a frequency band of 6 GHz or higher) than a frequency band (e.g., a frequency band of 6 GHz or lower) of a long term evolution (LTE) based communication system (or, a LTE-A based communication system) is being considered for processing of soaring wireless data. The NR can support not only a frequency band above 6 GHz but also a frequency band below 6 GHz, and can support various communication services and scenarios compared to the LTE. Further, the requirements of the NR may include enhanced mobile broadband (eMBB), ultra reliable low latency communication (URLLC), massive machine type communication (mMTC), and the like.

Meanwhile, in a downlink transmission procedure of the LTE, a downlink channel (e.g., a downlink control channel, a downlink data channel) and reference signals (e.g., demodulation reference signal (DMRS)) used for demodulating the downlink channel may be transmitted. In the NR, reference signals may also be used for downlink transmission. However, since the NR uses a wider frequency band than the LTE, reference signal configuration/transmission methods different from the reference signal configuration/transmission methods specified in the LTE may be required. Furthermore, reference signal configuration/transmission methods for meeting the requirements of the NR (e.g., eMBB, URLLC, mMTC, etc.) may be required.

### DISCLOSURE

### Technical Problem

The objective of the present invention to solve the above-described problem is to provide methods for transmitting and receiving a downlink channel and a reference signal in a communication system.

### Technical Solution

A method for receiving a downlink signal performed by a terminal according to a first embodiment of the present invention for achieving the above-described objective may comprise receiving a control demodulation reference signal (DMRS) for a downlink control channel from a base station in a time-frequency resource region #1; performing demodulation and decoding operations on the downlink control channel in the time-frequency resource region #1 by using channel estimation information #1 based on the control DMRS; performing demodulation and decoding operations on a downlink data channel by using the channel estimation information #1 in a frequency band A in a time-frequency resource region #2 indicated by scheduling information obtained from the downlink control channel; and performing demodulation and decoding operations on the downlink data channel in a frequency band B in the time-frequency resource region #2 by using channel estimation information #2 based on a data DMRS received in the frequency band B, wherein a frequency band of the time-frequency resource region #1 includes the frequency band A, and a frequency band of the time-frequency resource region #2 includes the frequency bands A and B.

Here, the downlink control channel may be received in a control resource set or a physical downlink control channel (PDCCH) search space.

Here, the number of antenna ports for the control DMRS may be equal to the number of antenna ports for the data DMRS.

Here, the number of transmission layers for the control DMRS may be equal to the number of transmission layers for the data DMRS.

Here, a rate matching operation around the downlink control channel may be performed to receive the downlink data channel

Here, information indicating that the control DMRS is used for demodulating the downlink data channel may be received through a signaling from the base station.

Here, the control DMRS may be allocated in the frequency band A of at least one symbol commonly included in the time-frequency resource region #1 and the time-frequency resource region #2, and the data DMRS may be allocated in the frequency band B of the at least one symbol.

Here, when a time period of the time-frequency resource region #2 is composed of M symbols, additional data DMRS for the downlink data channel may be received in an i-th symbol among the M symbols, each of M and i may be an integer equal to or greater than 2, and i may be equal to or less than M.

Here, a precoding applied to the additional data DMRS may be identical to a precoding applied to the control DMRS in each of physical resource blocks (PRBs).

A method for receiving a downlink signal performed by a terminal according to a second embodiment of the present invention for achieving the above-described objective may comprise receiving a control demodulation reference signal (DMRS) from a base station in a time-frequency resource region #1 configured for a control resource set; performing demodulation and decoding operations on a downlink control channel in the time-frequency resource region #1 by using channel estimation information #1 based on the control DMRS; and performing demodulation and decoding operations on a downlink data channel by using the channel estimation information #1 in a time-frequency resource region #2 indicated by scheduling information obtained from the downlink control channel, wherein the time-frequency resource region #1 overlaps with the time-frequency resource region #2, a frequency band of the time-frequency resource region #1 includes frequency bands A1 and A2, the control DMRS is received in the frequency bands A1 and A2, and the downlink control channel is received in the frequency band A1.

Here, the control DMRS may be a wideband DMRS transmitted through an entire frequency band of the control resource set.

Here, the downlink control channel may be received through some time-frequency resource region in the control resource set.

Here, a rate matching operation may be performed around the downlink control channel or the control resource set to receive the downlink data channel

Here, information indicating that the control DMRS is used for demodulating the downlink data channel may be received through a signaling from the base station.

A method for transmitting a downlink signal performed by a base station according to a third embodiment of the present invention for achieving the above-described objective may comprise transmitting a downlink control channel, a control demodulation reference signal (DMRS), and a downlink data channel #1 in a frequency band A; and transmitting a downlink data channel #2 and a data DMRS in a frequency band B, wherein the control DMRS is used for demodulating the downlink control channel and the downlink data channel #1 transmitted in the frequency band A, and the data DMRS is used for demodulating the downlink data channel #2 transmitted in the frequency band B.

Here, the number of antenna ports for the control DMRS may be equal to the number of antenna ports for the data DMRS.

Here, the number of transmission layers for the control DMRS may be equal to the number of transmission layers for the data DMRS.

Here, a rate matching operation may be performed around the downlink control channel to transmit and receive the downlink data channels #1 and #2.

Here, information indicating that the control DMRS is used for demodulating the downlink data channel #1 may be transmitted through a signaling of the base station.

Here, an additional data DMRS used for demodulating the downlink data channels #1 and #2 may be transmitted in the frequency bands A and B.

### Advantageous Effects

According to the present invention, resource element groups (REGs) or REG groups can be distributed in the frequency domain by performing interleaving on the REGs or the REG groups constituting a control channel element (CCE), so that a frequency diversity gain for the CCE (e.g., a downlink control channel transmitted in the CCE) can be improved.

Further, a wideband demodulation reference signal (DMRS) can be used in a downlink transmission procedure. In this case, channel estimation performance and synchronization estimation performance can be improved. Alternatively, a narrowband DMRS can be used in the downlink transmission procedure to reduce the DMRS overhead.

Further, a control DMRS (e.g., physical downlink control channel (PDCCH) DMRS) for demodulating a downlink control channel can be used for demodulating the downlink data channel In this case, a data DMRS (e.g., physical downlink shared channel (PDSCH) DMRS) for demodulating the downlink data channel may not be transmitted in the frequency band in which the control DMRS is transmitted, so that the DMRS overhead can be reduced. Also, in order to improve the channel estimation performance, additional data DMRS for demodulating the downlink data channel can be used.

### DESCRIPTION OF DRAWINGS

FIG. 1 is a conceptual diagram illustrating a first embodiment of a communication system.

FIG. 2 is a block diagram illustrating a first embodiment of a communication node constituting a communication system.

FIG. 3A is a conceptual diagram illustrating a first embodiment of CCE-REG mapping.

FIG. 3B is a conceptual diagram illustrating a second embodiment of CCE-REG mapping.

FIG. 3C is a conceptual diagram illustrating a third embodiment of CCE-REG mapping.

FIG. 3D is a conceptual diagram illustrating a fourth embodiment of CCE-REG mapping.

FIG. 4A is a conceptual diagram illustrating a first embodiment of a DMRS allocation method.

FIG. 4B is a conceptual diagram illustrating a second embodiment of a DMRS allocation method.

FIG. 4C is a conceptual diagram illustrating a third embodiment of a DMRS allocation method.

FIG. 4D is a conceptual diagram illustrating a fourth embodiment of a DMRS allocation method.

FIG. 5A is a conceptual diagram illustrating a first embodiment of a DMRS allocation method when Method 300 is used.

FIG. 5B is a conceptual diagram illustrating a second embodiment of a DMRS allocation method when Method 300 is used.

FIG. 5C is a conceptual diagram illustrating a third embodiment of a DMRS allocation method when Method 300 is used.

FIG. 5D is a conceptual diagram illustrating a fourth embodiment of a DMRS allocation method when Method 300 is used.

FIG. 6A is a conceptual diagram illustrating a first embodiment of a DMRS allocation method when Method 310 is used.

FIG. 6B is a conceptual diagram illustrating a second embodiment of a DMRS allocation method when Method 310 is used.

FIG. 6C is a conceptual diagram illustrating a third embodiment of a DMRS allocation method when Method 310 is used.

FIG. 6D is a conceptual diagram illustrating a fourth embodiment of a DMRS allocation method when Method 310 is used.

FIG. 7A is a conceptual diagram illustrating a fifth embodiment of a DMRS allocation method when Method 310 is used.

FIG. 7B is a conceptual diagram illustrating a sixth embodiment of a DMRS allocation method when Method 310 is used.

FIG. 7C is a conceptual diagram illustrating a seventh embodiment of a DMRS allocation method when Method 310 is used.

FIG. 8A is a conceptual diagram illustrating a first embodiment of a wideband/narrowband DMRS allocation method.

FIG. 8B is a conceptual diagram illustrating a second embodiment of a wideband/narrowband DMRS allocation method.

FIG. 8C is a conceptual diagram illustrating a third embodiment of a wideband/narrowband DMRS allocation method.

FIG. 9A is a conceptual diagram illustrating a first embodiment of a control resource set allocation method.

FIG. 9B is a conceptual diagram illustrating a second embodiment of a control resource set allocation method.

FIG. 10 is a conceptual diagram illustrating a first embodiment of REG bundling in frequency domain when a wideband DMRS is used.

FIG. 11 is a conceptual diagram illustrating a first embodiment of a REG interleaving method when a wideband DMRS is used.

FIG. 12 is a conceptual diagram illustrating a first embodiment of a block interleaving method.

FIG. 13 is a conceptual diagram illustrating a first embodiment of an REG interleaving method according to Method 200.

FIG. 14 is a conceptual diagram illustrating a second embodiment of an REG interleaving method according to Method 200.

FIG. 15 is a conceptual diagram illustrating a third embodiment of an REG interleaving method according to Method 200.

FIG. 16 is a conceptual diagram illustrating a fourth embodiment of an REG interleaving method according to Method 200.

FIG. 17 is a conceptual diagram illustrating a first embodiment of an REG interleaving method according to Methods 200 to 203.

FIG. 18 is a conceptual diagram illustrating a first embodiment of an REG group-level interleaving method.

FIG. 19 is a conceptual diagram illustrating a first embodiment of a PRB-level interleaving method.

FIG. 20A is a conceptual diagram illustrating a first embodiment of a CCE-REG mapping method for a control resource set composed of 3 symbols.

FIG. 20B is a conceptual diagram illustrating a second embodiment of a CCE-REG mapping method for a control resource set composed of 3 symbols.

FIG. 21 is a conceptual diagram illustrating a first embodiment of an REG interleaving method according to Method 210.

FIG. 22 is a conceptual diagram showing a first embodiment of an REG interleaving method according to Method 211.

FIG. 23A is a conceptual diagram illustrating a first embodiment of a DMRS allocation method when a non-slot-based PDSCH scheduling scheme is used.

FIG. 23B is a conceptual diagram illustrating a second embodiment of a DMRS allocation method when a non-slot-based PDSCH scheduling scheme is used.

FIG. 23C is a conceptual diagram illustrating a third embodiment of a DMRS allocation method when a non-slot-based PDSCH scheduling scheme is used.

FIG. 24A is a conceptual diagram illustrating a first embodiment of a DMRS allocation method according to Method 410.

FIG. 24B is a conceptual diagram illustrating a second embodiment of a DMRS allocation method according to Method 410.

FIG. 25 is a conceptual diagram illustrating a third embodiment of a DMRS allocation method according to Method 410.

### MODES OF THE INVENTION

While the present invention is susceptible to various modifications and alternative forms, specific embodiments are shown by way of example in the drawings and described in detail. It should be understood, however, that the description is not intended to limit the present invention to the specific embodiments, but, on the contrary, the present invention is to cover all modifications, equivalents, and alternatives that fall within the spirit and scope of the present invention.

Although the terms “first,” “second,” etc. may be used herein in reference to various elements, such elements should not be construed as limited by these terms. These terms are only used to distinguish one element from another. For example, a first element could be termed a second element, and a second element could be termed a first element, without departing from the scope of the present invention. The term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directed coupled” to another element, there are no intervening elements.

The terminology used herein is for the purpose of describing particular embodiments only and is not intended to be limiting of embodiments of the present invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, parts, and/or combinations thereof, but do not preclude the presence or addition of one or more other features, integers, steps, operations, elements, parts, and/or combinations thereof.

Unless otherwise defined, all terms (including technical and scientific terms) used herein have the same meaning as commonly understood by those of ordinary skill in the art to which the present invention pertains. It will be further understood that terms defined in commonly used dictionaries should be interpreted as having a meaning that is consistent with their meaning in the context of the related art and will not be interpreted in an idealized or overly formal sense unless expressly so defined herein.

Hereinafter, exemplary embodiments of the present invention will be described in greater detail with reference to the accompanying drawings. To facilitate overall understanding of the present invention, like numbers refer to like elements throughout the description of the drawings, and description of the same component will not be reiterated.

The communication systems to which embodiments according to the present invention are applied will be described. The communication system may be a 4G communication system (e.g., a long-term evolution (LTE) communication system, an LTE-A communication system), a 5G communication system (e.g. a new radio (NR) communication system), or the like. The 4G communication system can support communication in a frequency band of 6 GHz or less, and the 5G communication system can support communication in a frequency band of 6 GHz or less as well as a frequency band of 6 GHz or more. The communication system to which the embodiments according to the present invention are applied is not limited to the following description, and the embodiments according to the present invention can be applied to various communication systems. Here, the communication system may be used in the same sense as a communication network.

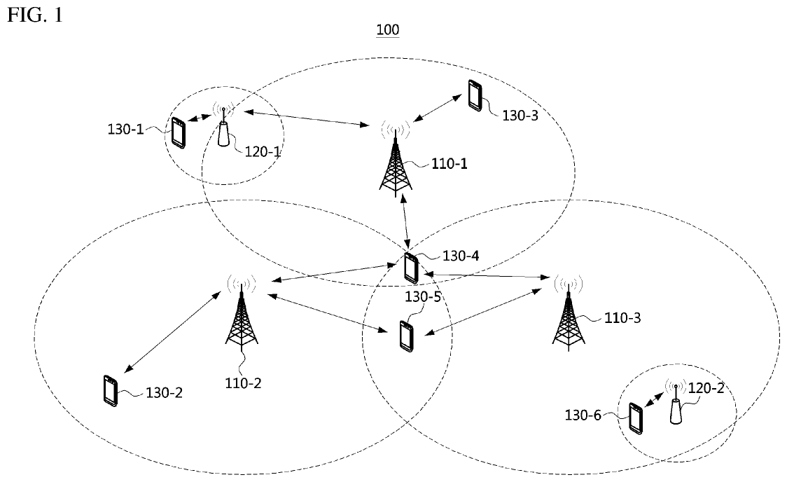

FIG. 1 is a conceptual diagram illustrating a first embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Also, the communication system 100 may comprise a core network (e.g., a serving gateway (S-GW), a packet data network (PDN) gateway (P-GW), a mobility management entity (MME), and the like). When the communication system 100 is a 5G communication system (e.g., a new radio (NR) system), the core network may include an access and mobility management function (AMF), a user plane function (UPF), a session management function (SMF), and the like.

The plurality of communication nodes 110 to 130 may support a communication protocol (e.g., long term evolution (LTE) communication protocol, LTE-advanced (LTE-A) communication protocol, NR communication protocol) defined in the 3rd generation partnership project (3GPP) standard. The plurality of communication nodes 110 to 130 may support at least one communication protocol among a code division multiple access (CDMA) technology, a wideband CDMA (WCDMA) technology, a time division multiple access (TDMA) technology, a frequency division multiple access (FDMA) technology, an orthogonal frequency division multiplexing (OFDM) technology, a filtered OFDM technology, a cyclic prefix (CP)-OFDM technology, a discrete Fourier transform-spread-OFDM (DFT-s-OFDM) technology, an orthogonal frequency division multiple access (OFDMA) technology, a single carrier FDMA (SC-FDMA) technology, a non-orthogonal multiple access (NOMA) technology, a generalized frequency division multiplexing (GFDM) technology, a filter band multi-carrier (FBMC) technology, an universal filtered multi-carrier (UFMC) technology, a space division multiple access (SDMA) technology, and the like. Each of the plurality of communication nodes may have the following structure.

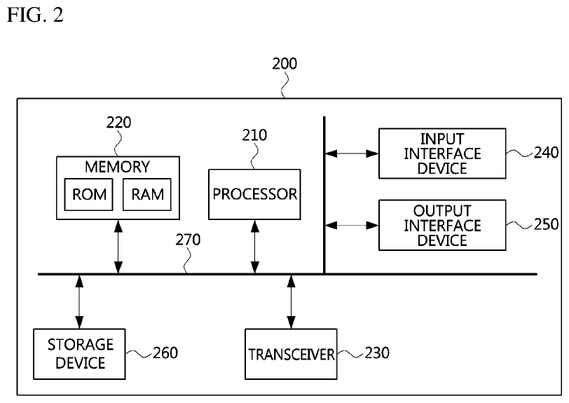

FIG. 2 is a block diagram illustrating a first embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 comprising the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may be referred to as a Node B (NodeB), an evolved Node B (eNodeB), a gNB, an advanced base station (ABS), a high reliability-base station (HR-BS), a base transceiver station (BTS), a radio base station, a radio transceiver, an access point (AP)), an access node, a radio access station (RAS), a mobile multihop relay-base station (MMR-BS), a relay station (RS), an advanced relay station (ARS), a high reliability-relay station (HR-RS), a home NodeB (HNB), a home eNodeB (HeNB), a road side unit (RSU), a radio remote head (RRH), a transmission point (TP), a transmission and reception point (TRP), or the like.

Each of the plurality of terminals 130-1, 130-2, 130-3, 130-4, 130-5, and 130-6 may be referred to as a user equipment (UE), a terminal equipment (TE), an advanced mobile station (AMS), a high reliability-mobile station (HR-MS), a terminal, an access terminal, a mobile terminal, a station, a subscriber station, a mobile station, a portable subscriber station, a node, a device, a mounted module, an on board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Also, each of the plurality of base stations 110-1, 110-2, 110-3, 120-1, and 120-2 may support a multi-input multi-output (MIMO) transmission (e.g., a single-user MIMO (SU-MIMO), a multi-user MIMO (MU-MIMO), a massive MIMO, or the like), a coordinated multipoint (CoMP) transmission, a carrier aggregation (CA) transmission, a transmission in unlicensed band, a device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Meanwhile, in the communication system, a physical channel may be used to transmit information obtained from a higher layer from a transmitter (e.g., base station or terminal) to a receiver (e.g., terminal or base station) by using radio resources such as time, frequency, and space. The physical channel may include a control channel, a data channel, and the like.

For example, a base station may transmit downlink control information (DCI) to a terminal through a downlink control channel, and transmit common data (e.g., broadcast information, system information) and terminal-specific data (UE-specific data) the terminal. Also, the terminal may transmit uplink control information (UCI) to the base station through an uplink control channel, and may transmit terminal-specific data and UCI through an uplink data channel The terminal-specific data may include user plane data and control plane data.

Here, the downlink control channel may be a physical downlink control channel (PDCCH), and the downlink data channel may be a physical downlink shared channel (PDSCH). The DCI may include common information (e.g., system information, configuration information for a random access procedure, paging information, etc.), terminal-specific information (e.g., scheduling information for uplink/downlink data channels, etc.), and the like. In the case of LTE, a resource region in which the PDCCH is transmitted may be composed of up to 3 or 4 consecutive symbols in the time domain, and all physical resource blocks (PRBs) belonging to a system bandwidth in the frequency domain In the first symbol among the symbols used for the PDCCH in the time domain, the PDCCH may coexist with a physical control format indicator channel (PCFICH) or a physical hybrid automatic repeat request (ARQ) indicator channel (PHICH).

On the other hand, in order to meet the requirements of the NR communication system (e.g., forward compatibility, high flexibility, etc.), physical channels (e.g., uplink channels, downlink channels) of the NR communication system may be configured differently from the physical channels of the LTE communication system. For example, the NR communications system may support various numerologies (e.g., a set of various waveform parameters) as shown in Table 1 below. A power-of-two multiple relationship may hold between subcarrier spacings in the respective numerologies. The CP length may be scaled at the same rate as the symbol (e.g., OFDM symbol) length.

TABLE 1

| Numerology index | #0 | #1 | #2 | #3 | #4 |
|---|---|---|---|---|---|
| Subcarrier spacing | 15 kHz | 30 kHz | 60 kHz | 120 kHz | 240 kHz |
| OFDM symbol | 66.7 | 33.3 | 16.7 | 8.3 | 4.2 |
| length (μs) | | | | | |
| CP length (μs) | 4.76 | 2.38 | 1.19 | 0.60 | 0.30 |
| Number of OFDM | 14 | 28 | 56 | 112 | 224 |
| symbols within | | | | | |
| 1 ms | | | | | |

A time domain building block in a frame structure of the NR communication system may be a subframe, a slot, a mini-slot, or the like. The length of the subframe may be 1 ms regardless of the subcarrier spacing. That is, the length of the subframe may be a fixed value. The slot may be composed of 14 consecutive symbols (e.g., OFDM symbols) regardless of the subcarrier spacing. Accordingly, the length of the slot may be variable, unlike the length of the subframe. That is, the length of the slot may be inversely proportional to the subcarrier spacing. The slot may be a minimum scheduling unit, and scheduling information (e.g., DCI) of a downlink data channel may be transmitted through a PDCCH for each slot or each group of slots.

The slot type may be classified into a downlink slot including only a downlink period, an uplink slot including only an uplink period, and a bi-directional slot including both a downlink period and an uplink period. The bi-directional slot may be used in a communication system supporting a time division duplex (TDD) mode. A guard period may be inserted between the downlink period and the uplink period, and the length of the guard period may be set to be larger than a sum of a delay spread and two times of a propagation delay. Instead of explicitly defining a guard period, an unknown period may be defined which consists of one or more unknown symbols. The unknown period may be inserted between a downlink period and an uplink period, between a downlink period and a downlink period, and between an uplink period and an uplink period. When the unknown period is inserted between a downlink period and an uplink period, the unknown period may be used as a guard period. A plurality of slots may be aggregated, and one data packet or transport block (TB) may be transmitted through the aggregated slots.

The length of the mini-slot may be less than the length of the slot. The mini-slot may be used for increasing time-division multiplexing (TDM) capability for analog or hybrid beamforming in a frequency band above 6 GHz, transmission of a partial slot in an unlicensed band, transmission of a partial slot in a frequency band in which the NR communication system coexists with the LTE communication system, ultra-reliable and low latency communication (URLLC) transmission, and the like.

The length and starting position of the mini-slot may be defined as flexible as possible to support the embodiments described above. For example, when the number of symbols (e.g., OFDM symbols) occupied by one slot is M, the mini-slot may be composed of one or more consecutive symbols among the M symbols, and the transmission of the mini-slot may be started from an arbitrary symbol within the slot. Also, the terminal may monitor PDCCHs for each mini-slot or mini-slot group. The mini-slot may be configured by the base station, and the base station may transmit configuration information of the mini-slot to the terminal. Alternatively, instead of explicitly configuring the mini-slot, operations corresponding to the mini-slot may be performed based on a monitoring period of a control channel, a transmission period of a control channel, a data channel duration in the time domain, and the like.

In the NR communication system, a frequency domain building block in a frame structure may be a PRB. One PRB may include 12 subcarriers irrespective of the numerology. Accordingly, the bandwidth occupied by one PRB may be proportional to the subcarrier spacing of the numerology. For example, the bandwidth occupied by the PRB may be 720 kHz when the numerology index of Table 1 is #2 (i.e., subcarrier spacing of 60 kHz), and the bandwidth occupied by the PRB may be 180 kHz when the numerology index of Table 1 is #0 (i.e., subcarrier spacing of 15 kHz). The PRB may be a minimum scheduling unit of the control channel and the data channel in the frequency domain.

Next, a method of configuring a downlink control channel, a method of mapping physical resources to a downlink control channel, a method of precoding, a method of arranging reference signals, and a method of configuring a downlink data channel will be described. The following embodiments may be applicable to other communication systems (e.g., LTE communication system) as well as the NR communication system. Even when a method (e.g., transmission or reception of a signal) to be performed at a first communication node among communication nodes is described, a corresponding second communication node may perform a method (e.g., reception or transmission of the signal) corresponding to the method performed at the first communication node. That is, when an operation of a terminal is described, a corresponding base station may perform an operation corresponding to the operation of the terminal. Conversely, when an operation of the base station is described, the corresponding terminal may perform an operation corresponding to the operation of the base station.

In the NR communication system, a minimum resource unit constituting the downlink control channel (i.e., PDCCH) may be a resource element group (REG). The REG may be composed of one PRB (e.g., 12 subcarriers) in the frequency domain and may be composed of one symbol (e.g., OFDM symbol) in the time domain. Thus, one REG may comprise 12 resource elements (REs). The RE may be a minimum physical resource unit consisting of one subcarrier and one symbol (e.g., OFDM symbol). The 12 REs included in the REG may be used to transmit encoded DCI. Alternatively, some REs among the 12 REs included in the REG may be used to transmit a reference signal (e.g., demodulation reference signal (DMRS)) used for demodulating the PDCCH. When the DMRS is transmitted in the REG, the number of REs to which the DCI is mapped in the REG may be reduced by the number of REs to which the DMRS is mapped.

One PDCCH candidate may be composed of one control channel element (CCE) or aggregation of a plurality of CCEs, and one CCE may include a plurality of REGs. In the following embodiments, a CCE aggregation level may be referred to as ‘L’, and the number of REGs constituting one CCE may be referred to as ‘K’. For example, when L=4 and K=6, the PDCCH may be composed of 24 REGs. The higher the CCE aggregation level, the more physical resources may be used for PDCCH transmission. In this case, the PDCCH reception performance can be improved by reducing the code rate.

A control resource set (CORESET) may indicate a resource region in which the terminal performs blind decoding of the PDCCH. The control resource set may be composed of a plurality of REGs. The control resource set may be composed of a plurality of PRBs in the frequency domain, and may be composed of one or more symbols (e.g., OFDM symbols) in the time domain. The symbols constituting one control resource set may be continuous in the time domain, and the PRBs constituting one control resource set may be continuous or discontinuous in the frequency domain.

The terminal may receive the PDCCH based on the blind decoding (e.g., the blind decoding method defined in the LTE communication system). In this case, a search space may indicate a set of candidate resource regions through which the PDCCH can be transmitted, the terminal may perform blind decoding on each of the PDCCH candidates in a predefined search space, and the terminal may determine whether the PDCCH is transmitted to itself through a cyclic redundancy check (CRC) according to the blind decoding. The terminal may receive the PDCCH when the terminal determines that the corresponding PDCCH is transmitted to itself.

The search space may be classified into a common search space and a terminal-specific search space (UE-specific search space). The common DCI may be transmitted in the common search space and the terminal-specific DCI (UE-specific DCI) may be transmitted in the terminal-specific search space. Considering scheduling degree of freedom, fallback transmission, etc., the terminal-specific DCI may be transmitted also in the common search space.

The control resource set may be classified into a common control resource set (common CORESET) and a terminal-specific control resource set (UE-specific CORESET). The common control resource set may indicate a resource region for initially monitoring a PDCCH when a terminal in a radio resource control (RRC) idle state performs initial access. Not only an RRC idle terminal but also an RRC connected terminal may monitor the common control resource set. The common control resource set may be configured in the terminal through system information transmitted through a physical broadcast channel (PBCH). On the other hand, the terminal-specific control resource set may be configured in the terminal through an RRC signaling procedure. Therefore, the terminal-specific control resource set may be valid for the terminal in the RRC connected state. The common control resource set may be configured in a frequency region used by the terminal in the initial access, and the terminal-specific control resource set may be configured in an arbitrary frequency region (e.g., bandwidth part) within an operating frequency region of the terminal.

The control resource set may be configured based on a distributed mapping scheme and a localized mapping scheme in the frequency domain. The REGs constituting one CCE may be discontinuous in the frequency domain when the distributed mapping scheme is used, and the REGs constituting one CCE may be continuous in the frequency domain when the localized mapping scheme is used.

When the control resource set is composed of one symbol in the time domain, the CCE may be composed of REGs located in the same symbol. When the control resource set is composed of a plurality of symbols, a rule may be required to map the REGs allocated to two-dimensional time-frequency resources to the CCE. For example, a ‘time-first mapping scheme’ or a ‘frequency-first mapping scheme’ may be used for CCE-REG mapping. When the time-first mapping scheme is used, the REGs constituting one CCE may be mapped to the time domain first, and then mapped to the frequency domain. When the frequency-first mapping scheme is used, the REGs constituting one CCE may be mapped to the frequency domain first, and then to the time domain.

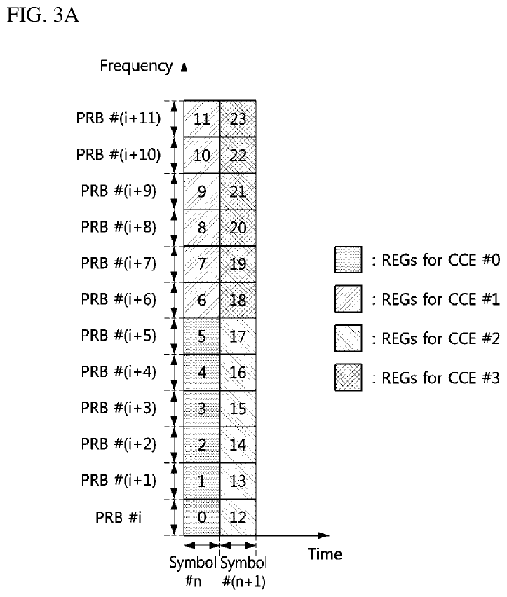

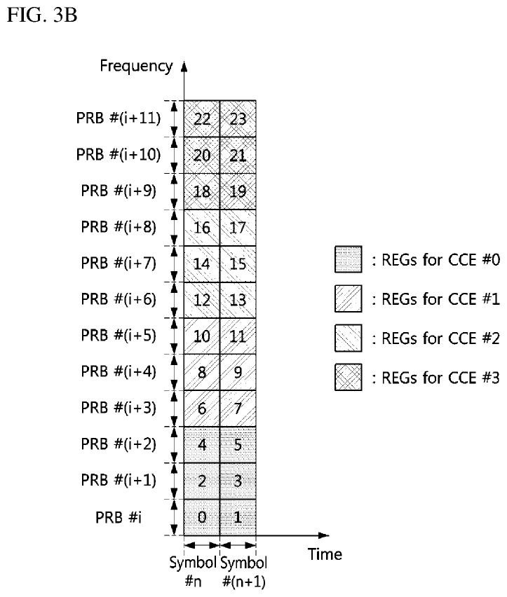

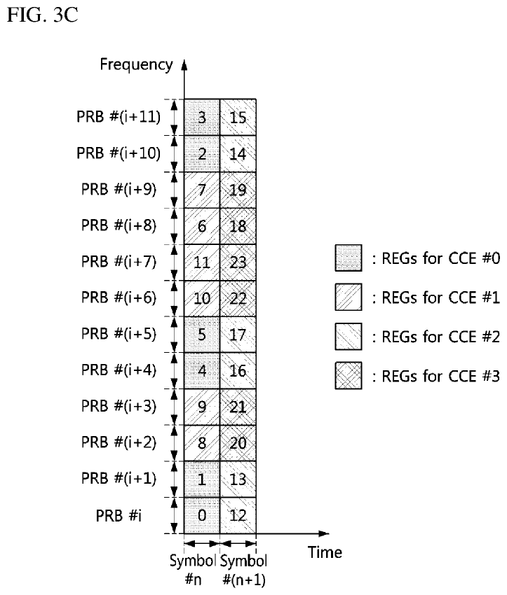

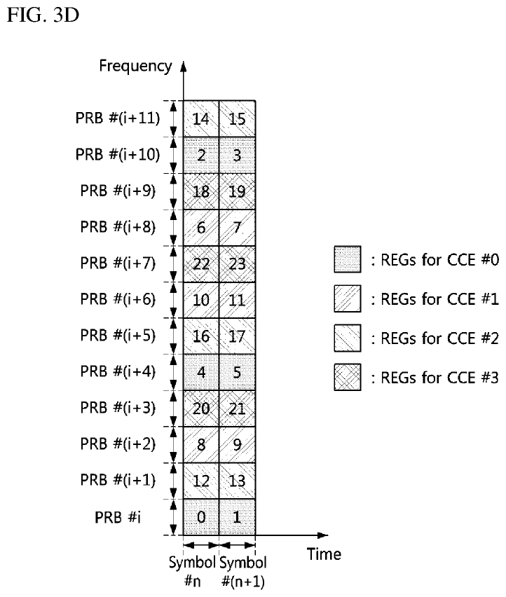

FIG. 3A is a conceptual diagram illustrating a first embodiment of CCE-REG mapping, FIG. 3B is a conceptual diagram illustrating a second embodiment of CCE-REG mapping, FIG. 3C is a conceptual diagram illustrating a third embodiment of CCE-REG mapping, and FIG. 3D is a conceptual diagram illustrating a fourth embodiment of CCE-REG mapping.

Referring to FIGS. 3A to 3D, a control resource set may be composed of 12 PRBs in the frequency domain, and may be composed of 2 symbols in the time domain. Here, each of n and i may be an integer equal to or greater than 0. The CCE-REG mapping in FIG. 3A may be performed based on the localized mapping scheme and the frequency-first mapping scheme, the CCE-REG mapping in FIG. 3B may be performed based on the localized mapping scheme and the time-first mapping scheme, the CCE-REG mapping in FIG. 3C may be performed based on the distributed mapping scheme and the frequency-first mapping scheme, and the CCE-REG mapping in FIG. 3D may be performed based on the distributed mapping scheme and the time-first mapping scheme.

In FIGS. 3A and 3C, since the CCE is configured in a localized manner in the time domain, the terminal may perform PDCCH decoding sequentially. In this case, a time delay due to the PDCCH decoding operation may be reduced, and a TDM-based multi-beam transmission may be efficiently performed. In FIGS. 3B and 3D, since the CCE is configured in the localized manner in the frequency domain, the transmission coverage of the PDCCH may be improved by improving a PDCCH transmission power, and an overhead due to DMRS transmission may be reduced.

Meanwhile, the DMRS may be mapped to some or all of the REGs constituting the PDCCH. Since the terminal should estimate a channel for the entire frequency region through which the PDCCH is transmitted, the DMRS may be mapped to at least one REG among the REGs located in the PRBs constituting the PDCCH. The DMRS used for demodulating the PDCCH may be referred to as ‘PDCCH DMRS’ or ‘control DMRS’. In the REG, the DMRS may be mapped as follows.

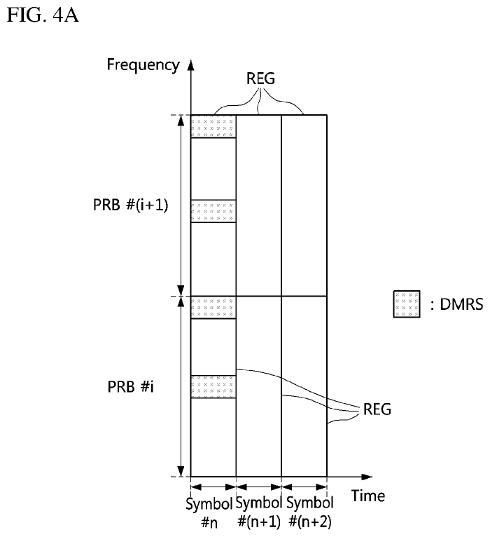

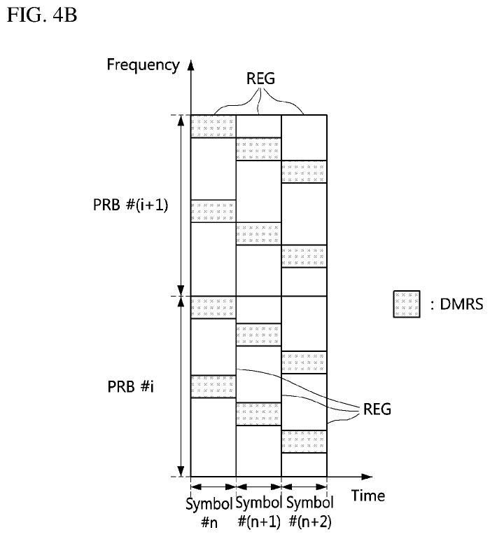

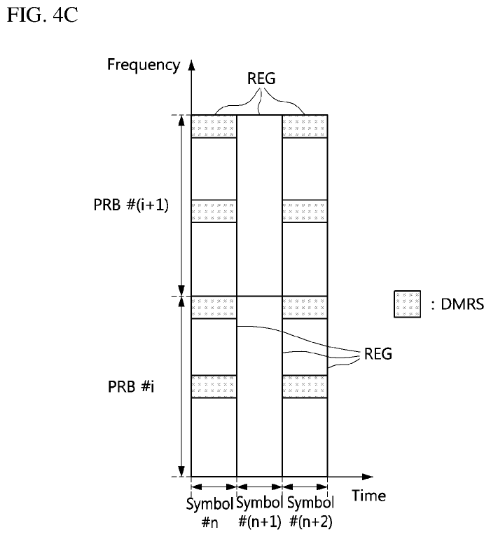

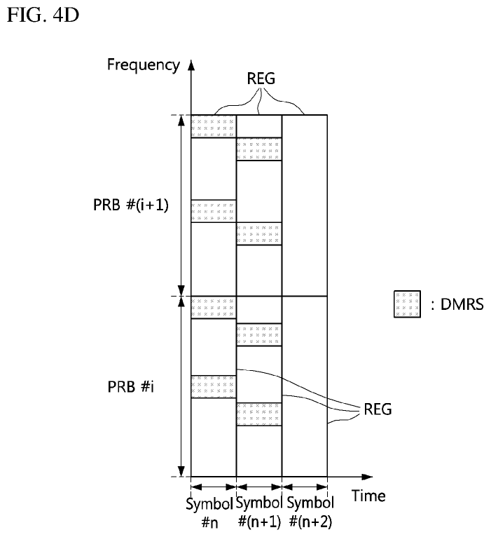

FIG. 4A is a conceptual diagram illustrating a first embodiment of a DMRS allocation method, FIG. 4B is a conceptual diagram illustrating a second embodiment of a DMRS allocation method, FIG. 4C is a conceptual diagram illustrating a third embodiment of a DMRS allocation method, and FIG. 4D is a conceptual diagram illustrating a fourth embodiment of a DMRS allocation method.

Referring to FIGS. 4A to 4D, there may be 2 REGs contiguous in the frequency domain, and there may be 3 REGs contiguous in the time domain Here, it may be assumed that 6 REGs are used for transmission of the same PDCCH. That is, the same precoding may be applied to all of the REs constituting the 6 REGs.

In the embodiment of FIG. 4A, the DMRS may be transmitted through the

REGs allocated in the first symbol (e.g., symbol #n) in the time domain among the REGs belonging to the same PRB. Here, each of n and i may be an integer equal to or greater than 0. In the embodiment of FIG. 4B, the DMRS may be transmitted through all REGs. In the embodiment of FIG. 4C, the DMRS may be transmitted through the REGs allocated in the first symbol (e.g., symbol #n) and the REGs located in the last symbol (e.g., symbol #(n+2)) among the REGs belonging to the same PRB (hereinafter referred to as ‘Method 300’). In the embodiment of FIG. 4D, the DMRS may be transmitted through the remaining REGs (e.g., the REGs located in the symbols #n and #(n+1)) except the REGs allocated in the last symbol (e.g., symbol #(n+2)) (hereinafter referred to as ‘Method 310’).

The DMRS overhead according to the embodiment of FIG. 4A may be lower than the DMRS overhead according to the embodiments of FIGS. 4B to 4D. However, in case of a low signal to noise ratio (SNR), a channel estimation performance according to the embodiment of FIG. 4A may be relatively low compared to those according to the embodiments of FIGS. 4B to 4D. The DMRS overhead according to the embodiment of FIG. 4B may be higher than the DMRS overhead according to the embodiments of FIGS. 4A, 4C and 4D. However, a channel estimation performance according to the embodiment of FIG. 4B may be relatively high compared to those according to the embodiments of FIGS. 4A, 4C, and 4D. When a code rate applied to the PDCCH is high, the performance degradation of the communication system due to the increase of the DMRS overhead may be large.

In the following description, Method 300 and Method 310 will be described in detail. The embodiments of FIGS. 4C and 4D may be methods in which 3 consecutive REGs belonging to a specific PRB in the time domain are used for PDCCH transmission. Alternatively, Method 300 and Method 310 may be applied regardless of the symbol (or symbol combination) occupied by the REGs used for PDCCH transmission. Other embodiments of Method 300 may be as follows.

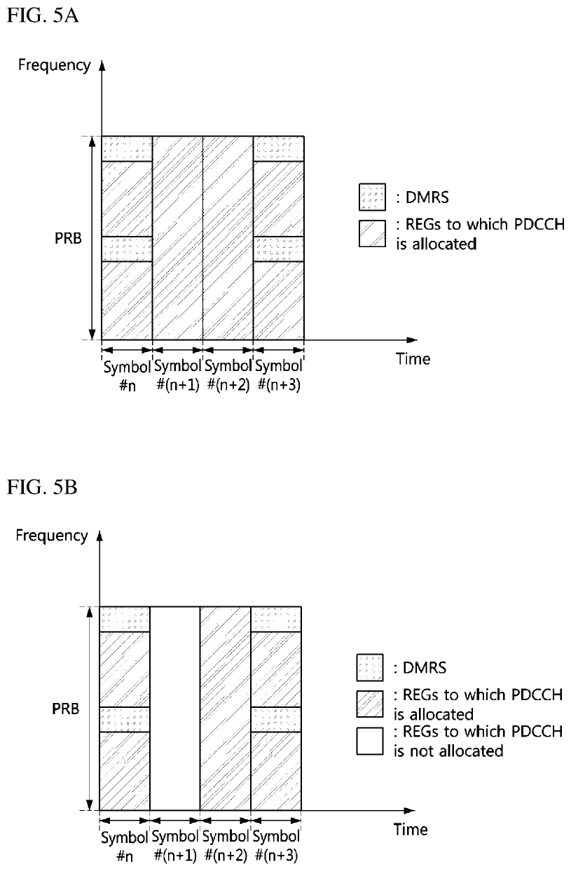

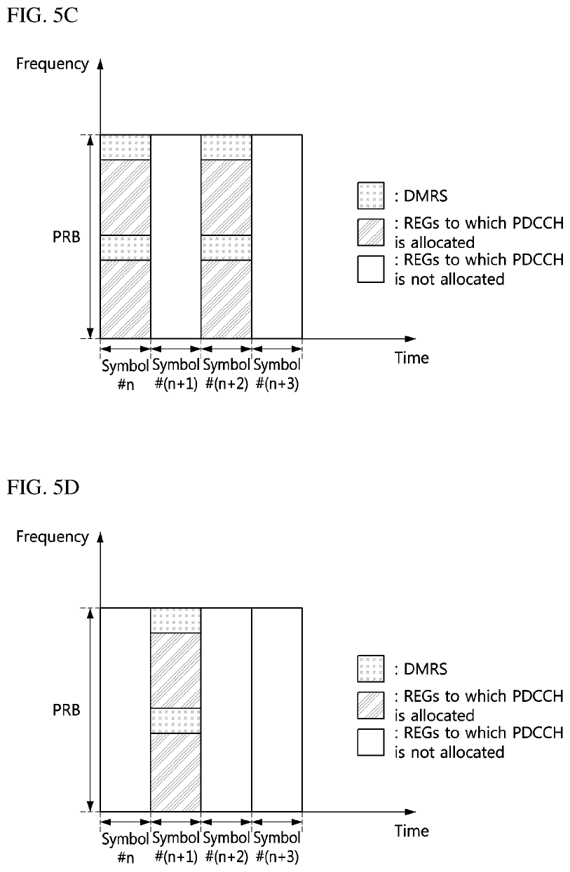

FIG. 5A is a conceptual diagram illustrating a first embodiment of a DMRS allocation method when Method 300 is used, FIG. 5B is a conceptual diagram illustrating a second embodiment of a DMRS allocation method when Method 300 is used, FIG. 5C is a conceptual diagram illustrating a third embodiment of a DMRS allocation method when Method 300 is used, FIG. 5D is a conceptual diagram illustrating a fourth embodiment of a DMRS allocation method when Method 300 is used.

Referring to FIGS. 5A to 5D, REGs used for PDCCH transmission may be located in 4 consecutive symbols (e.g., symbols #n to #(n+3)) belonging to one PRB. Here, n may be an integer equal to or greater than 0. In the embodiment of FIG. 5A, the REGs to which the PDCCH is allocated may be allocated in all the symbols (e.g., symbols #n to #(n+3)). In the embodiment of FIG. 5B, the REGs to which the PDCCH is allocated may be allocated in the remaining symbols (e.g., symbols #n, #(n+2), and #(n+3)) except the second symbol (e.g., symbol #(n+1)) among all the symbols (e.g., symbols #n to #(n+3)). In the embodiment of FIG. 5C, the REGs to which the PDCCH is allocated may be allocated in the first symbol (e.g., symbol #n) and the third symbol (e.g., symbol #(n+2)). In the embodiment of FIG. 5D, the REGs to which the PDCCH is allocated may be allocated in the second symbol (e.g., symbol #(n+1)).

According to Method 300, the DMRS may be transmitted through the REGs allocated in the first symbol and the REGs located in the last symbol among the REGs used for PDCCH transmission. In the embodiment of FIG. 5D, the first symbol in which the REGs used for the PDCCH transmission are allocated may be assumed to be the same as the last symbol in which the REGs used for the PDCCH transmission are allocated.

Method 300 may have several advantages over other embodiments of FIG. 4. Since the DMRS density of Method 300 in the time domain is higher than that of the DMRS density according to the embodiment of FIG. 4A, the channel estimation performance of Method 300 when REG bundling is applied in the time domain may be higher than the channel estimation performance according to the embodiment of FIG. 4A. Since the DMRS density of Method 300 in the time domain is lower than the DMRS density according to the embodiment of FIG. 4B, the number of REs used for transmission of control information in Method 300 may be greater than the number of REs used for transmission of control information in the embodiment of FIG. 4B. Although the channel estimation performance of Method 300 is lower than the channel estimation performance according to the embodiment of FIG. 4B, since the DMRS is located in edge symbols (e.g., first symbol and last symbol) in Method 300, the channel of the symbols disposed between the edge symbols may be accurately estimated by an interpolation method.

Meanwhile, other embodiments of Method 310 may be as follows.

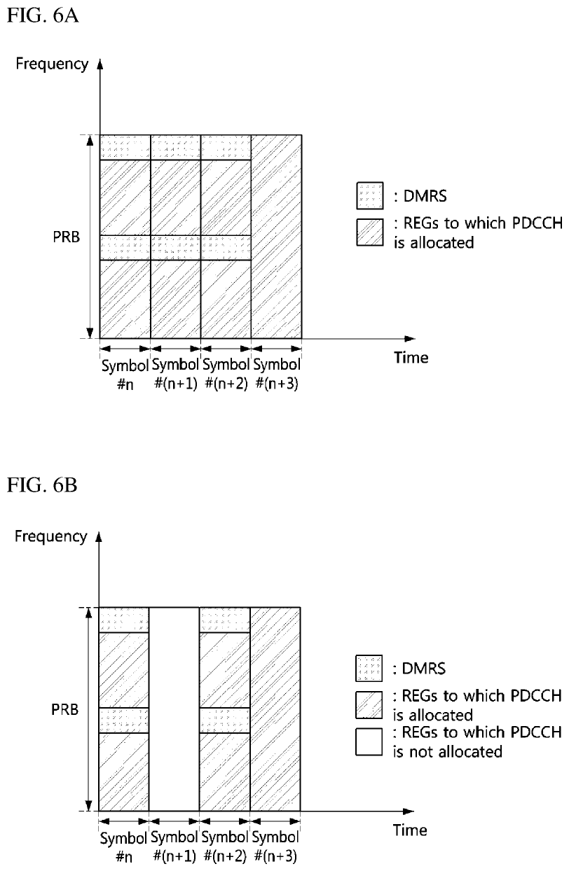

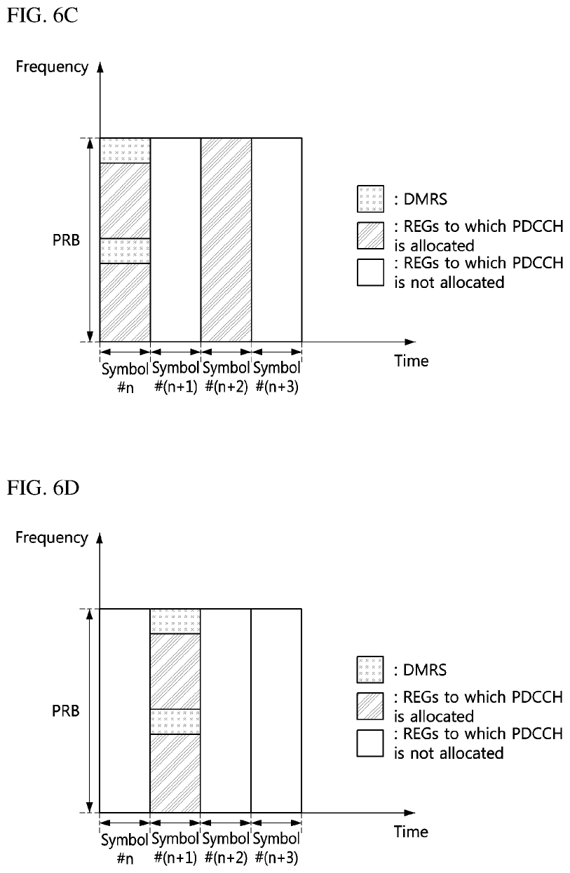

FIG. 6A is a conceptual diagram illustrating a first embodiment of a DMRS allocation method when Method 310 is used, FIG. 6B is a conceptual diagram illustrating a second embodiment of a DMRS allocation method when Method 310 is used, FIG. 6C is a conceptual diagram illustrating a third embodiment of a DMRS allocation method when Method 310 is used, and FIG. 6D is a conceptual diagram illustrating a fourth embodiment of a DMRS allocation method when Method 310 is used.

Referring to FIGS. 6A to 6D, REGs used for PDCCH transmission may be located in 4 consecutive symbols (e.g., symbols #n to #(n+3)) belonging to one PRB. Here, n may be an integer equal to or greater than 0. When Method 310 is supported, the DMRS may be transmitted through the remaining symbols except the last symbol among the symbols in which the REGs allocated to the PDCCH are allocated.

In the embodiment of FIG. 6A, the DMRS may be transmitted through the REGs allocated in the symbols #n to #(n+2), and the DMRS may not be transmitted through the REGs allocated in the last symbol (e.g., symbol #(n+3)). In the embodiment of FIG. 6B, the DMRS may be transmitted through the REGs allocated in the symbols #n and #(n+2), and the DMRS may not be transmitted through the REGs allocated in the last symbol (e.g., symbol #(n+3)). In the embodiment of FIG. 6C, the DMRS may be transmitted through the REGs allocated in the symbol #n, and the DMRS may not be transmitted through the REGs allocated in the last symbol (i.e., symbol #(n+3)). In the embodiment of FIG. 6D, the DMRS may be transmitted through the REGs allocated in symbol #(n+1).

In the embodiment of FIG. 6D, when REGs to which the PDCCH is allocated are allocated in one symbol in one PRB, the first symbol in which the REGs used for PDCCH transmission are allocated may be assumed to be the same as the last symbol in which the REGs used for PDCCH transmission are allocated. In this case, as an exception to Method 310, the DMRS may be transmitted through the corresponding REGs (i.e., the REGs allocated in the symbol #(n+1)). When Method 310 is used, the DMRS mapping may be performed such that the DMRS is transmitted through at least one REG among the REGs to which the PDCCH is allocated.

Method 310 may have several advantages over other embodiments of FIG. 4. Since the DMRS density of Method 310 in the time domain is higher than the DMRS density according to the embodiment of FIG. 4A, the channel estimation performance of Method 310 when REG bundling is applied in the time domain may be higher than the channel estimation performance according to the embodiment of FIG. 4A. For example, when the REGs to which the PDCCH is allocated are allocated in all the symbols (i.e., symbols #n to #(n+3)) as in the embodiment of FIG. 6A, the DMRS density of Method 310 in the time domain may be higher than the DMRS density of Method 300.

Since the DMRS density of Method 310 in the time domain is lower than the DMRS density according to the embodiment of FIG. 4B, the number of REs used for transmission of control information in Method 310 may be greater than the number of REs used for transmission of control information in the embodiment of FIG. 4B. Although the channel estimation performance of Method 310 is lower than the channel estimation performance according to the embodiment of FIG. 4B, since the DMRS is not transmitted through the last symbol in which the REGs to which the PDCCH is allocated are allocated (i.e., the DMRS is transmitted through symbol(s) before the last symbol), the terminal may perform the channel estimation operation in advance using the DMRS received through the symbol(s) before the last symbol for a time required for receiving the PDCCH allocated to the last symbol. Accordingly, the PDCCH reception processing time may be optimized in the terminal, and a time delay before the next operation in the terminal may be minimized

Meanwhile, the PDCCH may be transmitted in different symbols in different PRBs in the control resource set. For example, in case of a terminal-specific search space, CCEs constituting each of PDCCH candidates in the control resource set may be determined by a hashing function. When the control resource set is composed of a plurality of symbols and the frequency-first mapping scheme is used, since the CCEs belonging to the control resource set are two-dimensionally allocated in time-frequency resources, the PDCCH candidate may be composed of CCE(s) allocated to different symbols in the frequency domain in the corresponding control resource set. Embodiments according to the above may be as follows.

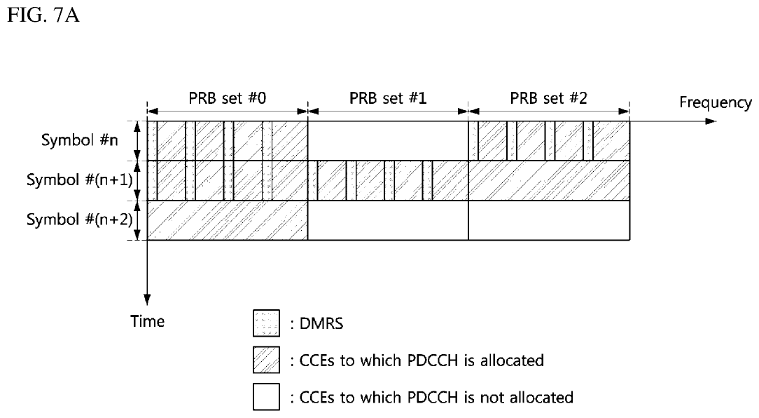

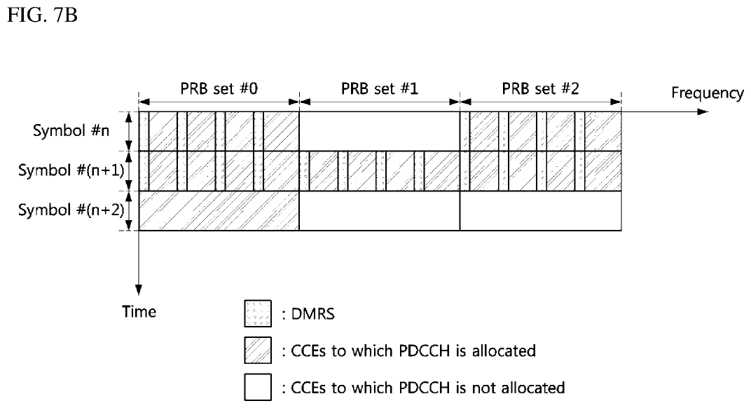

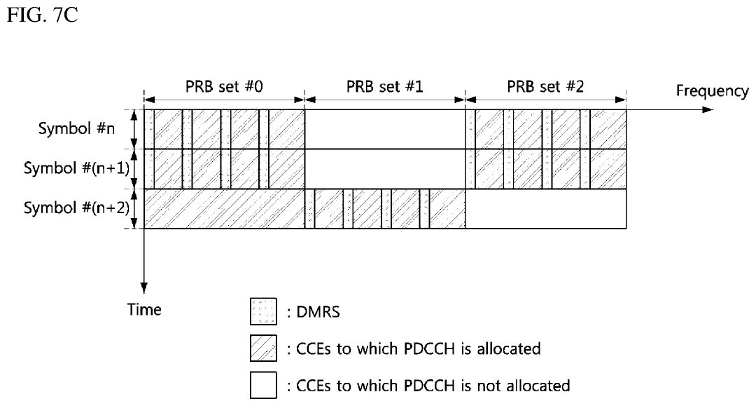

FIG. 7A is a conceptual diagram illustrating a fifth embodiment of a DMRS allocation method when Method 310 is used, FIG. 7B is a conceptual diagram illustrating a sixth embodiment of a DMRS allocation method when Method 310 is used, and FIG. 7C is a conceptual diagram illustrating a seventh embodiment of a DMRS allocation method when Method 310 is used.

Referring to FIGS. 7A to 7C, a control resource set may be composed of 3 symbols in the time domain and 3 PRB sets in the frequency domain. The PRB set may include J PRBs, and J may be an integer greater than or equal to 1. When J indicates the number of REGs per CCE and the frequency-first mapping scheme is used, a resource region composed of J PRBs and 1 symbol may be one CCE. Also, J may indicate the size of REG bundling or an interleaving unit in the frequency domain.

The PDCCH may be allocated to 6 CCEs and may be allocated to different symbols (or symbol sets) in each of the PRB sets. For example, the PDCCH may be allocated to 3 symbols (e.g., symbols #n to #(n+2)) in the PRB set #0, may be allocated to 1 symbol (e.g., symbol #(n+1) or #(n+2)) in the PRB set #1, and may be allocated to 2 symbols (e.g., symbols #n and #(n+1)) in the PRB set #2. Here, n may be an integer equal to or greater than 0.

Here, Method 310 may be applied based on two methods. In the first method (hereinafter referred to as ‘Method 311’), Method 310 may be applied on a PRB set basis. For example, in the embodiment of FIG. 7A, the DMRS may be transmitted through the remaining symbols except the last symbol among the symbols through which the PDCCH is transmitted for each PRB set. In the second method (hereinafter referred to as ‘Method 312’), Method 310 may be applied to all PRB sets. That is, the DMRS may be transmitted through the remaining symbols except the last symbol among the symbols through which the PDCCH is transmitted regardless of the PRB set. For example, in the embodiment of FIG. 7B, since the last symbol through which the PDCCH is transmitted among the symbols in which all the PRB sets are allocated is the symbol #(n+2), the DMRS may be transmitted through the remaining symbols (i.e., symbols #n and #(n+1)) except the last symbol among all the symbols.

Comparing the embodiment of FIG. 7A with the embodiment of FIG. 7B, the DMRS overhead of Method 311 may be lower than the DMRS overhead of Method 312. According to Method 312, the channel estimation performance may be improved by performing the DMRS mapping so that a maximum number of DMRSs are transmitted in consideration of the PDCCH reception processing time. The embodiment of FIG. 7C may be an exception to Method 312. In the PRB set #1 of FIG. 7C, the PDCCH may be transmitted only through the symbol #(n+2) which is the last symbol. According to Method 312, the DMRS may not be transmitted in the PRB set #1, and in this case, channel estimation may be impossible in the PRB set #1. Therefore, even when Method 312 is applied, if the PDCCH is allocated only to the last symbol of the corresponding PRB set, exceptionally, the DMRS may be transmitted through the last symbol of the corresponding PRB set. That is, the DMRS may be transmitted through at least one symbol in each of the PRB sets.

When the PDCCH candidate is mapped to different symbols in the frequency domain (e.g., the bandwidth occupied by one CCE) within the control resource set, the DMRS may be allocated in the time domain based on not only Method 310 but also other embodiments of FIG. 4. The DMRS allocation methods according to FIG. 4 may be applied to each PRB set as in Method 311. Alternatively, the DMRS allocation methods according to FIG. 4 may be applied to all PRB sets as in Method 312.

On the other hand, both Method 310 and the method of transmitting the DMRS through all REGs in the time domain (i.e., the embodiment of FIG. 4B) may be used. In this case, the base station may transmit information instructing to perform Method 310 or the embodiment of FIG. 4B to the terminal through a signaling procedure. Here, the signaling procedure may include a physical layer signaling procedure, a medium access control (MAC) layer signaling procedure (e.g., a MAC control element (CE)), an RRC signaling procedure, and the like. Also, a combination of signaling procedures (e.g., RRC signaling procedure+physical layer signaling procedure) may be used to transmit the information instructing to perform Method 310 or the embodiment of FIG. 4B. The signaling procedure may be performed for each control resource set. Alternatively, both of Method 300 and the embodiment of FIG. 4B may be used. In this case, the base station may transmit information instructing to perform Method 300 or the embodiment of FIG. 4B to the terminal through a signaling procedure.

On the other hand, the DMRS may be transmitted through the entire frequency region of the control resource set (i.e., all PRBs) in a specific symbol of the control resource set. The DMRS transmitted through the entire frequency region of the control resource set in a specific symbol of the control resource set may be referred to as a ‘wideband DMRS’. For example, the wideband DMRS may be transmitted through the entire frequency region of the control resource set in the first symbol of the control resource set. Alternatively, the DMRS may be transmitted through the PRB through which the PDCCH is transmitted within the control resource set. The DMRS transmitted through the PRB through which the PDCCH is transmitted within the control resource set may be referred to as a ‘narrowband DMRS’.

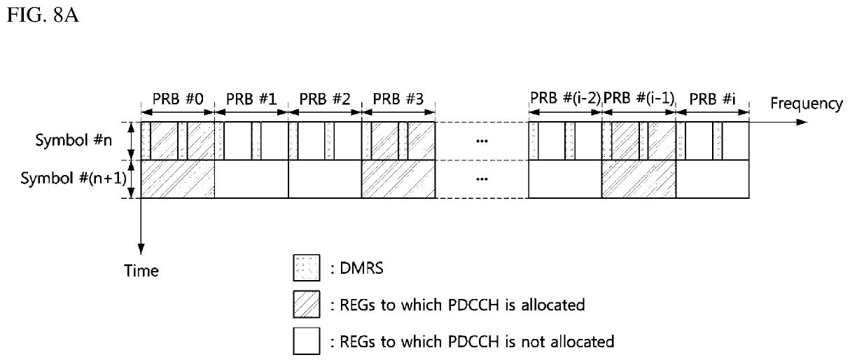

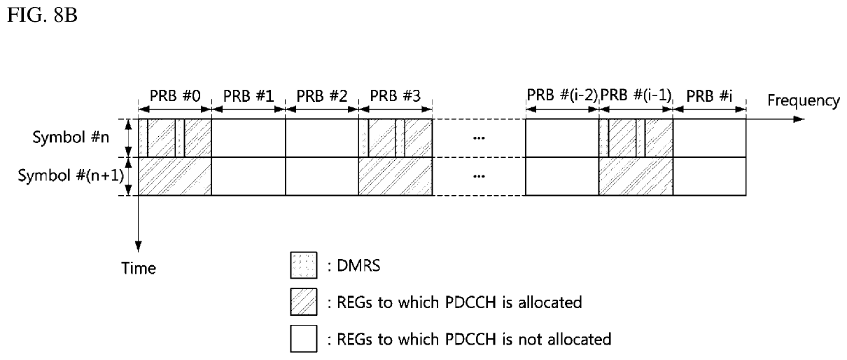

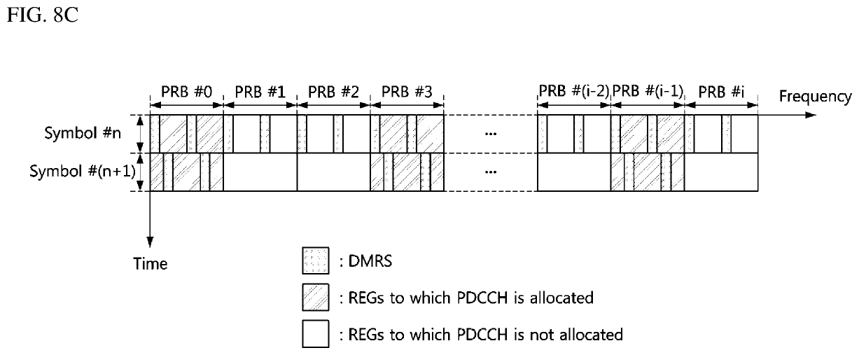

FIG. 8A is a conceptual diagram illustrating a first embodiment of a wideband/narrowband DMRS allocation method, FIG. 8B is a conceptual diagram illustrating a second embodiment of a wideband/narrowband DMRS allocation method, and FIG. 8C is a conceptual diagram illustrating a third embodiment of a wideband/narrowband DMRS allocation method.

Referring to FIGS. 8A to 8C, a control resource set may be composed of 2 symbols in the time domain, and may be composed of a plurality of PRBs in the frequency domain. The PDCCH may be allocated to some PRBs (e.g., REGs) belonging to the control resource set. In the embodiments of FIGS. 8A and 8B, the DMRS may be transmitted in the first symbol (e.g., symbol #n) of the control resource set. Here, n may be an integer equal to or greater than 0. The embodiment of FIG. 8A may be a wideband DMRS allocation method, and the wideband DMRS may be transmitted through the entire frequency region of the control resource set. That is, the wideband DMRS may be transmitted through the PRBs (e.g., REGs) to which the PDCCH is not allocated as well as the PRBs (e.g., REGs) to which the PDCCH is allocated.

The embodiment of FIG. 8B may be a narrowband DMRS allocation method and the narrowband DMRS may be transmitted through the PRBs (e.g., REGs) to which the PDCCH is allocated. The DMRS overhead due to the wideband DMRS may be larger than the DMRS overhead due to the narrowband DMRS. However, when the wideband DMRS is used, the REG bundle size may be increased compared to the narrowband DMRS, so that the channel estimation performance by the wideband DMRS may be improved as compared with the narrowband DMRS. In the embodiment of FIG. 8C, the wideband DMRS may be transmitted together with the narrowband DMRS. The wideband DMRS may be transmitted in a specific symbol (i.e., symbol #n) of the control resource set, and the narrowband DMRS may be transmitted in another symbol (i.e., symbol #(n+1)) of the control resource set.

The base station may inform the terminal through a signaling procedure of a set of symbol(s) through which the wideband DMRS is transmitted in the control resource set, and inform the terminal through a signaling procedure of a set of symbol(s) through which the narrowband DMRS is transmitted in the control resource set. For example, when both of the wideband DMRS and the narrowband DMRS are configured in a specific symbol of the control resource set through a signaling procedure, the terminal may determine that the wideband DMRS is transmitted through the specific symbol of the control resource set. When the wideband DMRS and the narrowband DMRS coexist, the REG bundle size in the frequency domain may be determined based on a precoder granularity for the wideband DMRS. For example, the terminal may assume that PRBs (e.g., REGs) consecutive in the frequency domain are one REG bundle, and that the same precoding is applied to the REG bundle. All the REGs belonging to the same PRB may form the same REG bundle.

In order to reduce the DMRS overhead, the wideband DMRS may be periodically transmitted. That is, the wideband DMRS may not be transmitted in every control resource set or every search space monitoring occasion. For example, the wideband DMRS may be transmitted through a control resource set (or search space) configured in the T-th slot or subframe, and T may be a natural number. Alternatively, an interval between control resource sets (or search spaces) to which the wideband DMRS is mapped in the time domain may be T, and the unit of T may be a slot or a subframe. Also, the symbols used for transmitting the wideband DMRS may be limited to specific symbols in the control resource set. For example, the wideband DMRS may be transmitted in the first symbol in the control resource set. Alternatively, in order to improve channel estimation performance, the wideband DMRS may be transmitted through a plurality of symbols in the control resource set.

The wideband DMRS may be transmitted over a frequency range wider than the frequency range of the control resource set (e.g., a wide band including the frequency range of the control resource set). For example, when the bandwidth of the control resource set is 10 MHz, the wideband DMRS may be transmitted over a 20 MHz bandwidth including the bandwidth of the control resource set. When the wideband DMRS is used for other purposes than the PDCCH demodulation (e.g., for measuring/tracking purposes of time-frequency synchronization of downlink signal), the wideband DMRS may transmitted over a frequency range wider than the frequency range of the control resource set. In order to improve synchronization measurement capability of the terminal, the wideband DMRS may be transmitted over a frequency range wider than the frequency range of the control resource set. Alternatively, the wideband DMRS may be transmitted through all PRBs constituting a downlink bandwidth part or through all available PRBs in which the control resource set can be configured. In this case, pattern, density, number of ports, and the like of the wideband DMRSs transmitted in the frequency region of the control resource set and a frequency region other than that of the control resource set may be different from each other.

Meanwhile, the control resource set may be located in a resource region to which the PDSCH is scheduled (hereinafter referred to as a ‘PDSCH resource region’) as shown below.

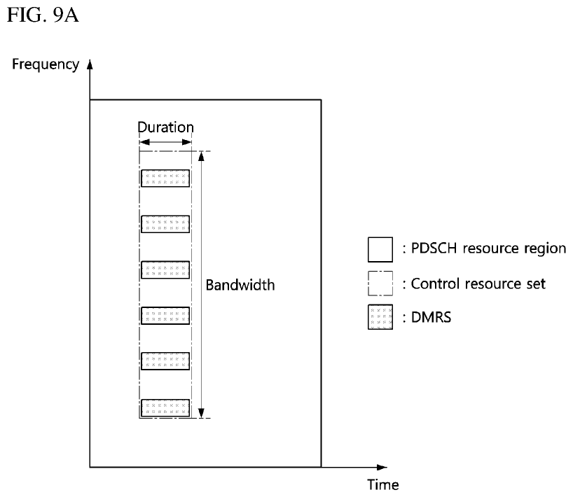

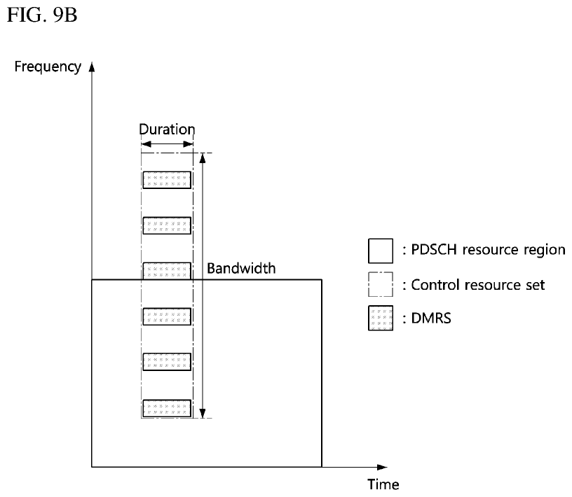

FIG. 9A is a conceptual diagram illustrating a first embodiment of a control resource set allocation method, and FIG. 9B is a conceptual diagram illustrating a second embodiment of a control resource set allocation method.

Referring to FIGS. 9A and 9B, a control resource set may overlap with the PDSCH resource region. In the region in which the control resource set is overlapped with the PDSCH resource region, data for the PDSCH may be transmitted in the remaining region except the resources to which the DMRS is mapped. In FIG. 9A, the entire control resource set may be overlapped with the PDSCH resource region. That is, the control resource set may be included in the PDSCH resource region. In FIG. 9B, a part of the control resource set may be overlapped with the PDSCH resource region. When the control resource set is overlapped with the PDSCH resource region, the base station may inform the terminal through a signaling procedure whether or not to perform a rate matching operation on the PDSCH.

Meanwhile, when the wideband DMRS is used for measuring/tracking time-frequency synchronization of downlink signal, the base station may configure the control resource set to the terminal as a means to configure the wideband DMRS. For example, in order to improve time-frequency synchronization measurement performance, the wideband DMRS may be configured not only in the front region of the slot but also in other regions. For example, when the wideband DMRS is configured in the first symbol of a slot, the wideband DMRS may be additionally configured in the fourth symbol of the slot. In this case, the base station may configure the control resource set in the fourth symbol of the slot.

Among the entire resource elements (REs) belonging to the control resource set configured for the purpose other than DCI (i.e., PDCCH) transmission, the REs other than the REs to which the wideband DMRS is mapped may be used for other purposes. When the control resource set is configured for the transmission of the wideband DMRS, the terminal may determine that the PDSCH is rate-matched to the REs to which the wideband DMRS is mapped among the REs belonging to the control resource set. That is, the terminal may determine that the PDSCH is transmitted through the REs other than the REs to which the wideband DMRS is mapped among the REs belonging to the region in which the control resource set is overlapped with the PDSCH resource region. In this case, the terminal may not monitor the PDCCH in the control resource set.

The base station may inform the terminal that the control resource set is configured only for the wideband DMRS transmission through a signaling procedure. The information indicating that the control resource set is configured only for the wideband DMRS transmission may be transmitted to the terminal together with the configuration information of the corresponding control resource set. The signaling procedure described above may be performed based on an explicit or implicit scheme. In the case that the signaling procedure based on the implicit scheme is used, the terminal may determine that the use of the control resource set is not for PDCCH monitoring when there is no search space logically associated with the control resource set. The terminal may identify the use of the control resource set through the signaling procedure, and determine whether to perform a rate matching operation on the PDSCH according to the purpose of the control resource set.

On the other hand, the above-described method may be generally used irrespective of the purpose of the control resource set. When the control resource set is configured for the wideband DMRS transmission and the rate matching operation on the PDSCH is configured to be performed in the control resource set, the terminal may perform the rate matching operation on the PDSCH in the corresponding control resource set. Alternatively, the PDSCH may be punctured in the REs used for the transmission of the wideband DMRS among the entire REs belonging to the control resource set. The terminal may know whether the PDSCH is punctured when the wideband DMRS is configured for the terminal. Accordingly, the terminal may set log likelihood ratio (LLR) values (e.g., soft bits) of the REs in which the PDSCH is punctured to 0, thereby minimizing the reception performance degradation of the PDSCH. When the REs used for the wideband DMRS are overlapped with the REs used for the DMRS for the PDSCH (hereinafter referred to as ‘PDSCH DMRS’ or ‘data DMRS’), the PDSCH DMRS in the overlapped REs may not be punctured. That is, both the wideband DMRS and the PDSCH DMRS may be transmitted in the overlapped REs. Alternatively, when the puncturing scheme for the PDSCH is used, the terminal may not expect that the REs used for the wideband DMRS and the REs used for the PDSCH DMRS are overlapped with each other.

When the control resource set and the PDSCH resource region are overlapped and the wideband DMRS is transmitted in the control resource set, both the wideband DMRS and the PDSCH DMRS may exist in the same PRBs located in the same symbol. In this case, the wideband DMRS and the PDSCH DMRS may be multiplexed by a frequency division multiplexing (FDM) scheme or a code division multiplexing (CDM) scheme. The pattern of wideband DMRS may be the same as the pattern of PDSCH DMRS. For example, when the PDSCH DMRS supports various DMRS patterns, one of the PDSCH DMRS patterns may be defined as the wideband DMRS pattern. When the CDM scheme is used, an orthogonal cover code (OCC) of the PDSCH DMRS may be different from an OCC of the wideband DMRS.

When the pattern of the PDSCH DMRS is different from the pattern of the wideband DMRS or the REs for the PDSCH DMRS are overlapped with the REs for the wideband DMRS in the same PRBs located in the same symbol, the terminal may determine that the PDSCH DMRS or the wideband DMRS is transmitted through the corresponding REs (i.e., overlapped REs). In the case where the transmission period of the wideband DMRS is several to several tens of slots, the synchronization measurement capability or the radio resource management (RRM) measurement performance due to the reception of the wideband DMRS may be more important than the PDSCH demodulation performance due to the reception of the PDSCH DMRS. In this case, the terminal may determine that the configuration of the wideband DMRS takes precedence over the configuration of the PDSCH DMRS in the overlapped REs (i.e., the REs used for transmitting the PDSCH DMRS and the wideband DMRS). On the other hand, when the PDSCH demodulation performance is more important than the synchronization measurement performance or the RRM measurement performance, the terminal may determine that the configuration of the PDSCH DMRS takes precedence over the configuration of the wideband DMRS in the overlapped REs (i.e., the REs used for transmitting the PDSCH DMRS and the wideband DMRS).

The configuration of the wideband DMRS may be performed separately from the configuration of the control resource set. For example, a signaling procedure for configuring the wideband DMRS may be performed independently of a signaling procedure for configuring the control resource set. When the wideband DMRS is configured by the base station, the terminal may determine that the PDSCH is rate-matched or punctured for the REs to which the wideband DMRS is mapped.

REG Bundling

The REG bundling may be used to improve the channel estimation performance of the terminal. One or more REGs may be configured as an REG bundle. The terminal may determine that the same precoding is applied to the REs belonging to the REGs constituting the REG bundle. In this case, the terminal may estimate a channel using all the DMRSs received in the REG bundle, thereby improving the channel estimation performance The REG bundling may be applied to consecutive REGs in the time domain or frequency domain. Here, the size of the REG bundle may indicate the number of REGs constituting the REG bundle. The REG bundle (e.g., the size of the REG bundle) may be defined in each of the time domain and the frequency domain. When the size of the REG bundle in the time domain is A and the size of the REG bundle in the frequency domain is B, the size of the REG bundle may be ‘A×B’.

REG Bundling in the Frequency Domain

When the wideband DMRS is used, the REG bundle in the frequency may be configured in common within the control resource set or search space. The terminal monitoring the control resource set or the search space may apply the common REG bundle to a receiver regardless of the mapping scheme of the PDCCH transmitted to the terminal. The REG bundle in the frequency domain may be configured as follows.

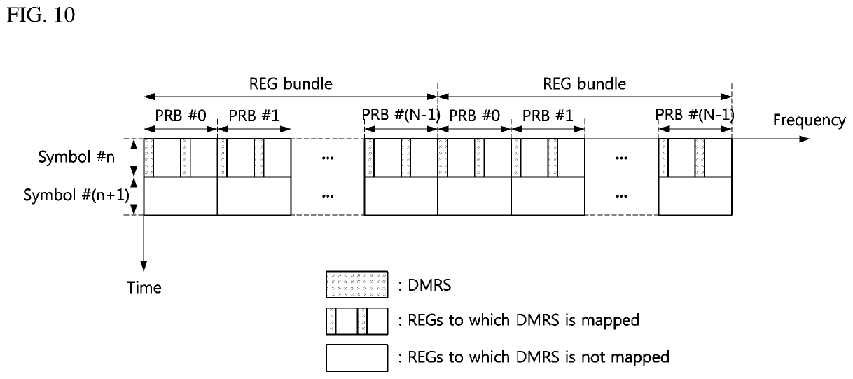

FIG. 10 is a conceptual diagram illustrating a first embodiment of REG bundling in frequency domain when a wideband DMRS is used.

Referring to FIG. 10, each of the REG bundles may include N consecutive PRBs (e.g., N REGs) in the frequency domain. Here, N may be a natural number. The REG bundles may be configured consecutively in the frequency domain. When the control resource set is composed of M PRBs (e.g., M REGs), the number V of REG bundles in the control resource set may be determined based on Equation 1 below. Here, M may be a natural number.

V=┌M/N┐ [Equation 1]

When M is not divided by N, the size of each of (V−1) REG bundles may be N and the size of the remaining one REG bundle may be ‘N-mod(M,N)’. For example, when the control resource set includes 96 PRBs (e.g., 96 REGs) and the size of the REG bundle in the frequency domain is 16, the number V of REG bundles in the control resource set may be 6. Alternatively, when the control resource set includes 100 PRBs (e.g., 100 REGs) and the size of the REG bundle in the frequency domain is 32, the number V of REG bundles in the control resource set may be 4. In this case, since 100 is not divided by 32, the size of each of 3 REG bundles may be 32, and the size of the remaining one REG bundle may be 4. The method of determining the number V of REG bundles based on Equation 1 may be referred to as ‘Method 100’.

On the other hand, when the narrowband DMRS is used, the REG bundle in the frequency domain may be configured according to a PDCCH mapping scheme (e.g., CCE-REG mapping scheme). When a CCE-REG mapping is performed based on a distributed mapping scheme, the REG bundling may be applied to each of CCEs. When one CCE is composed of one or more REG bundles in the frequency domain, the REG bundling may be applied to all REGs constituting each of the REG bundles in the frequency domain (hereinafter referred to as ‘Method 101’).

For example, in the embodiment of FIG. 3C, since the size of the REG bundle in the frequency domain is 2, the REG bundling may be applied to REGs constituting each of REG bundles according to Method 101. For the CCE #0, the REG bundling may be applied to each of the REG pairs (i.e., [0, 1], [2, 3] and [4, 5]). When the PDCCH is transmitted through the CCE #0, the terminal may determine that the same precoding is applied to each of the REG pairs, and may perform joint channel estimation based thereon. According to Method 101, the size of the REG bundle in the frequency domain may be a divisor of the number K of REGs included in the CCE.

When CCE-REG mapping is performed based on a localized mapping scheme, since the PDCCH is mapped to consecutive PRBs in the frequency domain, the REG bundling may be defined in the continuous frequency regions occupied by the PDCCH. When the localized mapping scheme is used, the size of the REG bundle may be determined in the same way as when the distributed mapping scheme is used. When the localized mapping scheme is used, the REGs constituting the PDCCH in the frequency domain are continuous, so that the application range of the REG bundling may not be limited to within one CCE. That is, the REG bundling may be applied between REGs included in different CCEs.

For example, in the embodiment of FIG. 3A, when the PDCCH is transmitted through the CCEs #0 and #1, the size of the REG bundle may be determined to be equal to the size of the REG bundle in the embodiment of FIG. 3C. For example, the size of the REG bundle may be 2, and the REG bundling may be applied to each of the REG pairs (i.e., [0, 1], [2, 3], [4, 5], [6, 7], [8, 9], and [10, 11]). Alternatively, the size of the REG bundle in the embodiment of FIG. 3A may be set to 4. In this case, the REG bundling may be applied to each of the REG groups (i.e., [0, 1, 2, 3], [4, 5, 6, 7] and [8, 9, 10, 11]). The REG group [4, 5, 6, 7] may include REG(s) belonging to the CCE #0 and REG(s) belonging to the CCE #1. Since the REGs belonging to the REG group [4, 5, 6, 7] are continuous in the frequency domain, the same precoding may be applied to the REG group [4, 5, 6, 7] (hereinafter referred to as ‘Method 102’).

The terminal may determine that different REG bundling configurations (e.g., REG bundle size, number of REG bundles, REG group to which REG bundles are applied) are applied in the frequency domain depending on the existence of the wideband DMRS. For example, in the control resource set or search space to which the wideband DMRS is mapped, the terminal may determine that the REG bundling configuration according to Method 100 is applied to the frequency domain. In the control resource set or search space to which the wideband DMRS is not mapped, the terminal may determine that the REG bundling configuration according to the PDCCH mapping scheme is applied to the frequency domain. The REG bundle when the wideband DMRS is used may be configured to be larger than the REG bundle when the wideband DMRS is not used, and the channel estimation performance may be higher when the wideband DMRS is used than when the narrowband DMRS is used.

REG Bundling in the Time Domain

The REG bundling in the time domain may be configured for REG(s) belonging to the same PRB constituting the same PDCCH. For example, in the embodiments of FIGS. 3B and 3D, the size of the REG bundle in the time domain may be 2. Also in the embodiments of FIGS. 3A and 3C (i.e., also in the embodiments in which the frequency-first mapping scheme is applied), if the same PDCCH is transmitted through REGs allocated in the symbols #0 and #1 belonging to the same PRB by CCE aggregation, the REG bundling may be configured to the REGs allocated in the symbols #0 and #1. When the PDCCH is transmitted by aggregation of the CCE #0 and #2, the size of the REG bundle in the time domain may be 2.

The REG bundling may be applied regardless of the DMRS mapping scheme in the time domain. When the DMRS is mapped to all the REGs belonging to the same PRB (e.g., in the embodiment of FIG. 4B) or when the DMRS is mapped to some REGs belonging to the same PRB (e.g., in the embodiments of FIGS. 4A and 4C), the REG bundling may be applied to the time domain That is, when the DMRS is mapped to all the REGs belonging to the same PRB, or when the DMRS is mapped to some REGs belonging to the same PRB, the terminal may determine that the same precoding is applied to the respective REG bundles.

On the other hand, even when the same PDCCH is transmitted through REGs belonging to the same PRB, the REG bundling may not be applied to the time domain. That is, the size of the REG bundle in the time domain may be set to 1. In this case, the terminal may determine that a different precoding is applied to each of symbols, and the base station may apply a different precoding to each of symbols to which the same PDCCH is allocated. Accordingly, the reception performance of the PDCCH can be improved. For example, the base station can improve a spatial diversity gain by applying a precoder cycling on a symbol-by-symbol basis in the time domain.

When the control resource set is composed of a plurality of symbols, REG bundling in the frequency domain may be equally applied to each of the symbols. Also, the REG bundling in the time domain may be equally applied to each of the PRBs constituting the control resource set. The REG bundling may be configured for each control resource set or search space in the time domain and frequency domain. The configuration of the frequency domain REG bundling may be independent of the configuration of the time domain REG bundling. That is, the REG bundling may be configured only in the frequency domain or in the time domain. Alternatively, the REG bundling may be configured simultaneously in the frequency domain and the time domain.

When the REG bundling is not configured, the default size of the REG bundle assumed by the terminal may be predefined in the specification. The default size of the REG bundle in the time domain may be 1. The default size of the REG bundle in the frequency domain may be determined according to whether the wideband DMRS is transmitted and the PDCCH mapping scheme. When the REG bundling is configured simultaneously in the time domain and the frequency domain, the terminal may assume a two-dimensional REG bundle. For example, in the embodiment of FIG. 3B, the size of the REG bundle in the frequency domain may be set to 3, and the size of the REG bundle in the time domain may be set to 2. When the PDCCH is transmitted through the CCE #0, the terminal may determine that the same precoding is applied to 6 REGs (i.e., REGs #0 to #5) constituting the CCE #0.

REG Interleaving

For distributed transmission of the PDCCH, an REG-level or REG group-level interleaving may be applied to the CCE-REG mapping procedure. The REG interleaving may be defined within the control resource set or search space. For distributed transmission of the PDCCH in the LTE communication system, the REGs may be distributed into a two-dimensional space of time-frequency resources through the interleaving. In the NR communication system, a case in which the narrowband DMRS is mapped to the control resource set for REG interleaving may be considered. Even when the distributed mapping scheme is used, it may not be preferable that REGs constituting one CCE are distributed into a two-dimensional space of time-frequency resources.

When the frequency-first mapping scheme is used, it may be preferable that each of the CCEs is mapped into one symbol. Thus, in the NR communication system, it may be preferable for the REG interleaving to be applied to each of the symbols in the control resource set or search space. The indexes of the M REGs allocated in each of the symbols may be permuted according to a predefined interleaving rule so that the mapping locations of the REGs in the frequency domain may also be permutated.

Referring back to FIGS. 3A and 3C, the mapping order of REGs #0 to #11 allocated in the first symbol (i.e., symbol #0) in the embodiment of FIG. 3A may be the mapping order before the REG interleaving is applied, and the mapping order of REGs #0 to #11 allocated in the first symbol (i.e., symbol #0) in the embodiment of FIG. 3C may be the mapping order after the REG interleaving is applied. In the embodiments of FIGS. 3A to 3D, the same REG pattern may be applied to the first symbol (i.e., symbol #0) and the second symbol (i.e., symbol #1), and when the time-first mapping scheme is used, the DMRS overhead can be reduced.

On the other hand, the CCE-REG mapping may be performed according to a fixed rule in the logical domain, regardless of how REGs are mapped to physical resources. The REGs #(n×K) to #((n+1)×(K−1)) may be mapped to the CCE #0 when the number of REGs belonging to the CCE is K in the case that a fixed rule is applied. Here, n may be an integer equal to or greater than 0. For example, when a fixed rule is applied, in the embodiments of FIGS. 3A to 3D, the CCE #0 may be mapped to the REGs #0 to #5, the CCE #1 may be mapped to the REGs #6 to #11, the CCE #2 may be mapped to the REGs #12 to #17, and the CCE #3 may be mapped to the REGs #18 to #23, irrespective of the manner in which the REGs are mapped to physical resources. When a fixed rule is applied, each of the above-described CCE-REG mapping schemes (e.g., distributed mapping scheme, localized mapping scheme, time-first mapping scheme, frequency-first mapping scheme) may indicate a method of mapping REGs to time-frequency resources in the control resource set.

When the narrowband DMRS is used, the REG bundling in the frequency domain may be applied to REGs constituting the same PDCCH. In this case, the level of the REG interleaving in the frequency domain may be a REG group with a size equal to the size of the REG bundle in the frequency domain. In the embodiments of FIGS. 3C and 3D, the level of REG interleaving may be a REG group having a size of 2.

On the other hand, when the wideband DMRS is used, the REG bundling in the frequency domain may be performed based on Method 100. That is, the frequency domain REG bundling may be configured in common in the control resource set to which the wideband DMRS is mapped, regardless of the PDCCH mapping scheme or the type of the resource region to which the PDCCH is allocated. In this case, the level of the REG interleaving in the frequency domain may not be highly related to the size of the REG bundle in the frequency domain. For example, in order to distribute the REGs belonging to the CCE as much as possible in the frequency domain, the level of REG interleaving may be set to 1 REG.

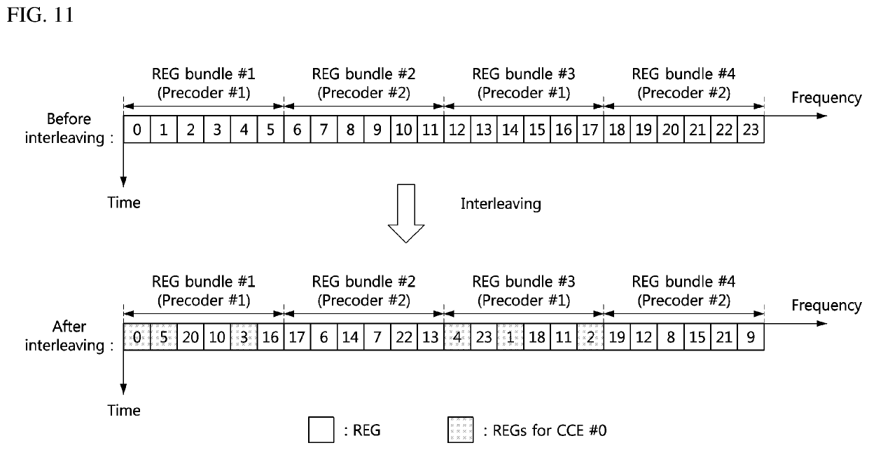

FIG. 11 is a conceptual diagram illustrating a first embodiment of a REG interleaving method when a wideband DMRS is used.

Referring to FIG. 11, a control resource set may be composed of 24 PRBs (e.g., 24 REGs), one CCE may be composed of 6 REGs, and the size of one REG bundle in the frequency domain may be 6. The base station may use two types of precoders, and may apply a precoder cycling to 4 REG bundles. That is, the precoder #1 may be applied to the REG bundle #1, the precoder #2 may be applied to the REG bundle #2, the precoder #1 may be applied to the REG bundle #3, and the precoder #2 may be applied to the REG bundle #4. The REGs #0 to #23 may be sequentially mapped to the PRBs #0 to #23 before performing the REG interleaving.

The REGs #0 to #5 may be configured as the CCE #0. When the PDCCH is transmitted through the CCE #0, since the same precoder is applied to all the REGs (e.g., REGs #0 to #5) through which the PDCCH is transmitted, the diversity gain according to the precoder cycling may not be obtained. Therefore, in order to increase the reliability of the PDCCH transmission, a mapping method may be required to prevent the REGs constituting one CCE from being concentrated only in a specific REG bundle(s). A block interleaving method for solving such the problem may be as follows.

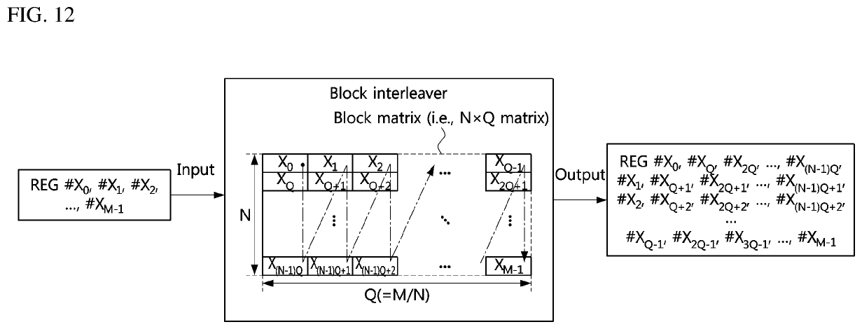

FIG. 12 is a conceptual diagram illustrating a first embodiment of a block interleaving method.

Referring to FIG. 12, when the number of REGs input to a block interleaver is M, the number of rows in a block matrix configured by an interleaving block may be N, and the number of columns in the block matrix configured by the interleaving block may be Q (i.e., M/N). Each of M, N and Q may be a positive integer, and M may be divided by N. A block interleaving pattern may be defined based on the block matrix (i. e, size N×Q matrix). The REGs #X₀, #X₂, #X₂, . . . , and #X_{M-1} input to the block interleaver may be first allocated in the rows of the block matrix. In this case, the REGs #X₀ to #X_{Q-1} may be allocated in the first row of the block matrix, the REGs #X_{Q} to #X_{2Q-1} may be allocated in the second row of the block matrix, and the REGs #X_{(N-1)Q} to #X_{M-1} may be allocated in the last row of the block matrix.

When the REG allocation in the block interleaver is completed, the REGs allocated in the columns in the block matrix may be output first. For example, the REGs allocated in the first row to the last row of the first column of the block matrix may be output first, then the REGs allocated in the first row to the last row of the second column of the block matrix may be output. Based on this scheme, up to the REGs allocated in the last column of the block matrix may be output. That is, the order of the REGs output from the block interleaver may be the REGs #X₀, #X_{Q}, #X_{2Q}, . . . , #X_{(N-1)Q}, #X₁, #X_{Q+1}, #X_{2Q+1}, . . . , #X_{(N-1)Q+1}, #X₂, #X_{Q+2}, #X_{2Q+2}, . . . , #X_{(N-1)Q+2}, . . . , #X_{Q-1}, #X_{2Q-1}, #X_{3Q-1}, . . . , and #X_{M-1}. The block interleaving method according to the embodiment of FIG. 12 may be referred to as ‘Method 200’.

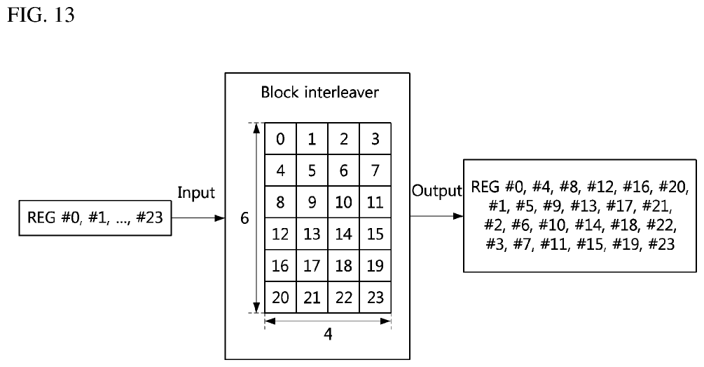

FIG. 13 is a conceptual diagram illustrating a first embodiment of an REG interleaving method according to Method 200.

Referring to FIG. 13, when the REGs #0 to #23 are input to the block interleaver, N of the block matrix is 6, and Q of the block matrix is 4, the order of the REGs output from the block interleaver may be the REGs #0, #4, #8, #12, #16, #20, #1, #5, #9, #13, #17, #21, #2, #6, #10, #14, #18, #22, #3, #7, #11, #15, #19, and #23.

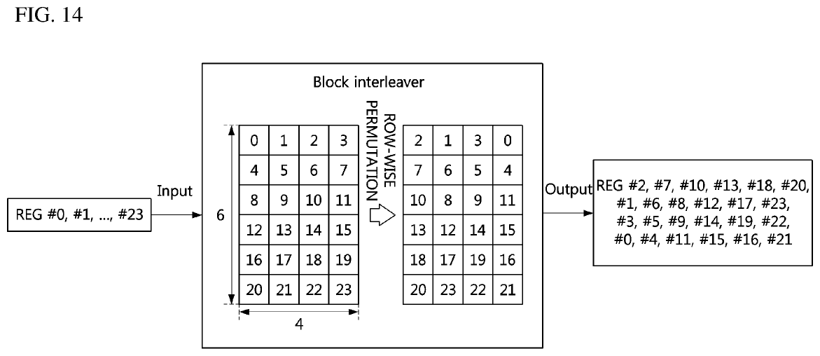

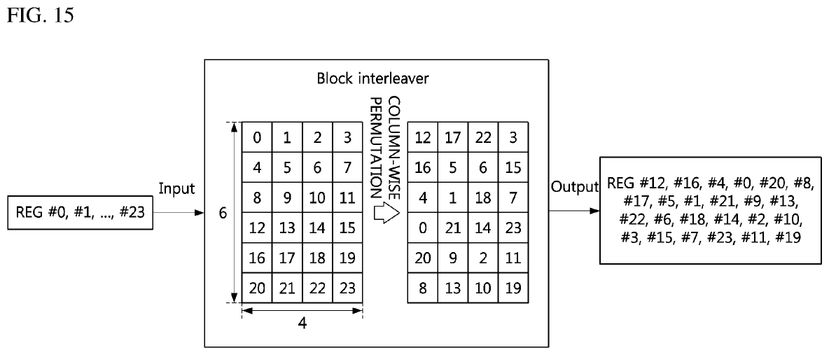

FIG. 14 is a conceptual diagram illustrating a second embodiment of an REG interleaving method according to Method 200.

Referring to FIG. 14, when the REGs #0 to #23 are input to the block interleaver, N of the block matrix is 6, and Q of the block matrix is 4, the block matrix generated by the block interleaver may be a 6×4 matrix. A row-wise permutation for the REGs allocated in each of the rows of the 6×4 matrix may be performed. The row-wise permutation may be respectively performed for the REGs #0 to #3 allocated in the first row of the block matrix, the REGs #4 to #7 allocated in the second row of the block matrix, the REGs #8 to #11 allocated in the third row of the block matrix, the REGs #12 to #15 allocated in the fourth row of the block matrix, the REGs #16 to #19 allocated in the fifth row of the block matrix, and the REGs #20 to #23 allocated in the sixth row of the block matrix.

When the row-wise permutation is completed, the REGs allocated in the column in the block matrix for which the row-wise permutation has been performed may be output first. For example, the REGs allocated in the first row to the last row of the first column of the block matrix for which the row-wise permutation is performed may be output first, and then the REGs allocated in the first row to the last row of the second column of the block matrix for which the row-wise permutation has been performed may be output. Based on this scheme, up to the REGs allocated in the last column of the block matrix for which the row-wise permutation has been performed may be output. That is, the order of the REGs output from the block interleaver may be the REGs #2, #7, #10, #13, #18, #20, #1, #6, #8, #12, #17, #23, #3, #5, #9, #14, #19, #22, #0, #4, #11, #15, #16, and #21. The above-described embodiment of FIG. 14 may be referred to as ‘Method 201’.

FIG. 15 is a conceptual diagram illustrating a third embodiment of an REG interleaving method according to Method 200.

Referring to FIG. 15, when the REGs #0 to #23 are input to the block interleaver, N of the block matrix is 6, and Q of the block matrix is 4, the block matrix generated by the block interleaver may be a 6×4 matrix. A column-wise permutation for the REGs allocated in each of the columns of the 6×4 matrix may be performed. The column-wise permutation may be respectively performed for the REGs #0, #4, #8, #12, #16 and #20 allocated in the first column of the block matrix, the REGs #1, #5, #9, #13, #17 and #21 allocated in the second column of the block matrix, the REGs #2, #6, #10, #14, #18 and #22 allocated in the third column of the block matrix, and the REGs #3, #7, #11, #15, #19 and #23 allocated in the fourth column of the block matrix.

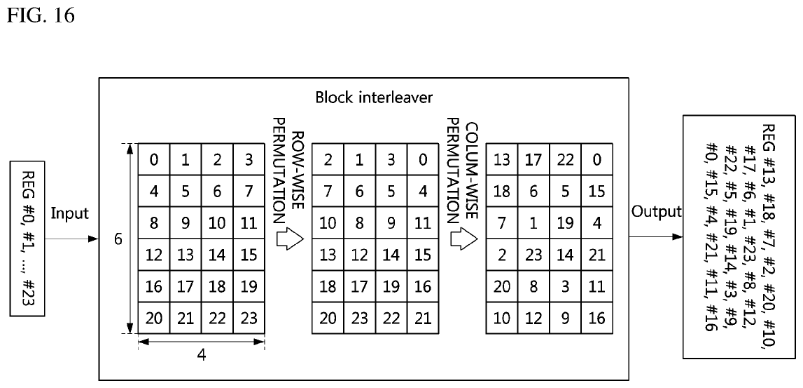

When the column-wise permutation is completed, the REGs allocated in the column in the block matrix for which the column-wise permutation has been performed may be output first. For example, the REGs allocated in the first row to the last row of the first column of the block matrix for which the row-wise permutation is performed may be output first, and then the REGs allocated in the first row to the last row of the second column of the block matrix for which the row-wise permutation has been performed may be output. Based on this scheme, up to the REGs allocated in the last column of the block matrix for which the column-wise permutation has been performed may be output. That is, the order of the REGs output from the block interleaver may be the REGs #12, #16, #4, #0, #20, #8, #17, #5, #1, #21, #9, #13, #22, #6, #18, #14, #2, #10, #3, #15, #7, #23, #11, and #19. The above-described embodiment of FIG. 14 may be referred to as ‘Method 202’ . FIG. 16 is a conceptual diagram illustrating a fourth embodiment of an REG interleaving method according to Method 200.

Referring to FIG. 16, when the REGs #0 to #23 are input to the block interleaver, N of the block matrix is 6, and Q of the block matrix is 4, the block matrix generated by the block interleaver may be a 6×4 matrix. The row-wise permutation for the REGs allocated in each of the rows of the 6×4 matrix may be performed, and the column-wise permutation may be performed on the REGs allocated in each of the columns of the block matrix for which the row-wise permutation has been performed. The embodiment of FIG. 16 may be referred to as a ‘Method 203’, and Method 203 may be a combination of Method 201 and Method 202. The order of the REGs output from the block interleaver according to Method 203 may be the REGs #13, #18, #7, #2, #20, #10, #17, #6, #1, #23, #8, #12, #22, #5, #19, #14, #3, #9, #0, #15, #4, #21, #11, and #16.

Meanwhile, ‘Method 204’ may be a combination of Method 202 and Method 201. When Method 204 is performed, a block matrix (i.e., N×Q matrix) may be generated from the block interleaver, the column-wise permutation for the REGs allocated in each of the columns of the block matrix may be performed, and the row-wise permutation may be performed on the REGs allocated in each of the rows of the block matrix for which the column-wise permutation has been performed. The REGs allocated in the column of the block matrix in which the column-wise and row-wise permutations have been performed may be output first.

In Method 201, Method 203, and Method 204, the row-wise permutations may be performed using the same pattern. In Method 202, Method 203, and Method 204, the column-wise permutations may be performed using the same pattern. In this case, a similar frequency diversity gain may be provided by the CCEs comprised of REGs distributed in the frequency domain. The results of applying the interleaving according to Methods 201 to 204 may be as follows.

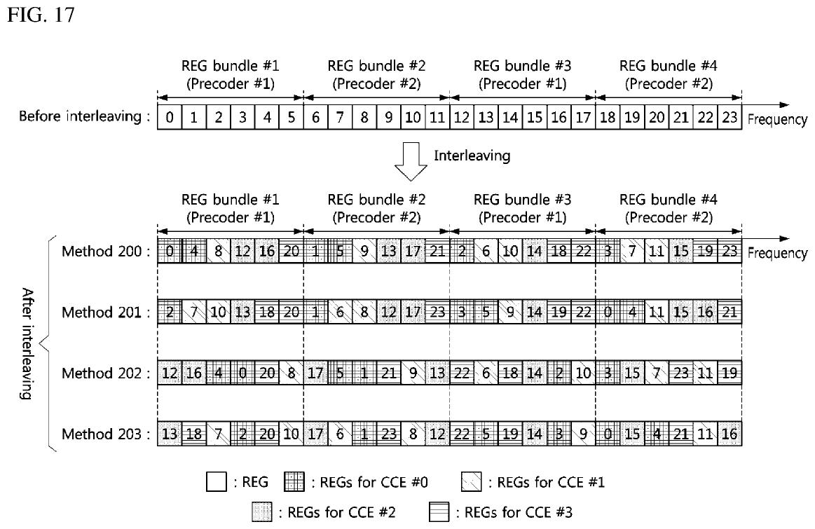

FIG. 17 is a conceptual diagram illustrating a first embodiment of an REG interleaving method according to Methods 200 to 203.

Referring to FIG. 17, a control resource set may be composed of 24 PRBs (e.g., 24 REGs), one CCE may be composed of 6 REGs, and the size of one REG bundle in the frequency domain may be 6. The base station may use two kinds of precoders, and may apply a precoder cycling to 4 REG bundles. That is, the precoder #1 may be applied to the REG bundle #1, the precoder #2 may be applied to the REG bundle #2, the precoder #1 may be applied to the REG bundle #3, and the precoder #2 may be applied to the REG bundle #4. The REGs #0 to #23 may be sequentially mapped to the PRBs #0 to #23 before performing the REG interleaving.

The REGs #0 to #5 may be configured as the CCE #0, the REGs #6 to #11 may be configured as the CCE #1, the REGs #12 to #17 may be configured as the CCE #2, and the REGs #18 to #23 may be configured as the CCE #3. After the REG interleaving according to Methods 200 to 203 is performed, 6 REGs constituting each of the CCEs #0 to #3 may be evenly distributed to 4 REG bundles. For example, after the REG interleaving according to Method 200 is performed, 2 REGs constituting the CCE #0 may be allocated in the REG bundle #1, 2 REGs constituting the CCE #0 may be allocated in the REG bundle #2, 1 REG constituting the CCE #0 may be allocated in the REG bundle #3, and 1 REG constituting the CCE #0 may be allocated in the REG bundle #4.

Therefore, when the base station applies a different precoder (e.g., precoder cycling) to each of the REG bundles, various precoders may be applied to the REGs belonging to each of the CCEs. For example, all of the precoders #1 and #2 may be applied to the REGs #0 to #5 belonging to the CCE #0. In this case, the PDCCH reception performance can be improved by the spatial diversity gain or the frequency diversity gain.

When Method 200 and Method 201 are used, the mapping locations of the REGs constituting the CCE in each of the REG bundles may be the same or similar. For example, the REGs constituting the CCE #0 may be mapped to the first PRB or the second PRB in each of the REG bundles #1 to #4.

When Method 202 and Method 203 are used, the mapping locations of the REGs constituting the CCE in each of the REG bundles may be different. That is, when the column-wise permutation is additionally applied, the mapping locations of the REGs constituting the CCE in each of the REG bundles may be different from each other. When Method 202 and Method 203 are used, the distribution effect of the CCE in the frequency domain can be improved and the probability that the REGs constituting the CCE are concentrated in the edge region of each REG bundle can be relatively lowered. In this case, uniform channel estimation performance can be provided between the CCEs.

The above-described interleaving method may be performed not only on an REG basis but also on an REG group basis. When the interleaving method is performed on a REG group basis, the REG group may be composed of consecutive REGs in the frequency domain, and the sizes of the REG groups may be the same. The REG group-level interleaving may be performed as follows.

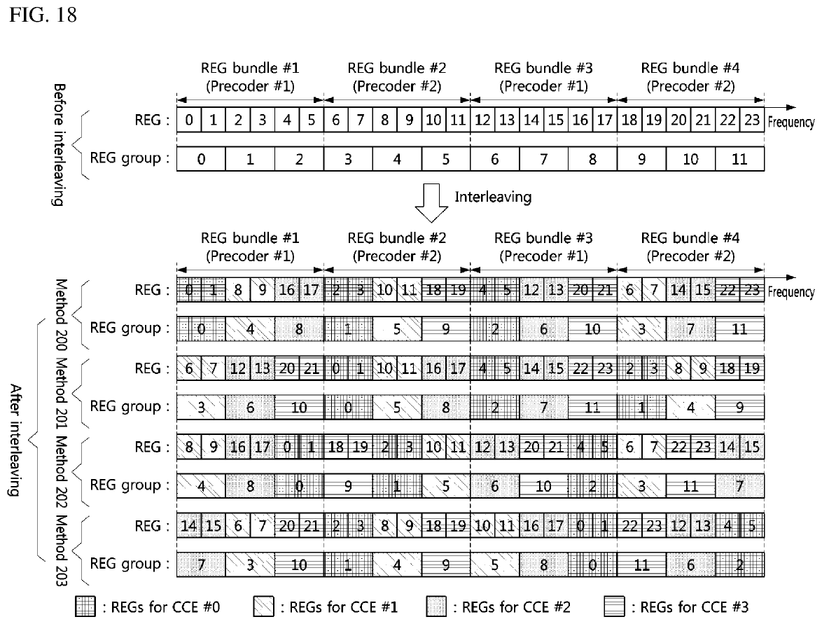

FIG. 18 is a conceptual diagram illustrating a first embodiment of an REG group-level interleaving method.

Referring to FIG. 18, each of the REG groups may include 2 REGs. For example, the REG group #1 may include the REGs #0 and #1, the REG group #2 may include the REGs #2 and #3, and the REG group #11 may include the REGs #22 and #23. Here, the number K of REGs included in the CCE may be 6, and the number N of rows of the block matrix configured by the block interleaver may be 12.

When the number of REGs included in the REG group (i.e., the size of the REG group) is referred to as ‘D’, the interleaver length (i.e., the number of REGs or REG groups input to the block interleaver) and the number of rows of the block matrix in each of the REG group-level interleaving method and the REG-level interleaving method may be as shown in Table 2 below.

TABLE 2

| | REG group-level | REG-level |
|---|---|---|
| | interleaving | interleaving |
| Interleaver length | M/D | M |
| Number of rows | N/D | N |
| of block matrix | | |

Each of M and N may be a multiple of D, and the number Q of columns of the block matrix may be the same in each of the REG group-level interleaving method and the REG-level interleaving method regardless of the size of the REG group. Although parameters (i.e., interleaver length and number of rows of the block matrix) used in the REG group-level interleaving method are different from parameters used in the REG-level interleaving method, the REG group-level interleaving method may be performed identically to or differently from the REG-level interleaving method.

When the number D of REGs included in the REG group is 2, the length (M/D) of the block interleaver may be 12, the number (N/D) of rows of the block matrix may be 3, and the number Q of columns of the block matrix may be 4. The block matrix configured by the block interleaver may be a 3×4 matrix, a row-wise permutation pattern for each row of the 3×4 matrix may be defined, and a column-wise permutation pattern for each column of the 3×4 matrix may be defined. When REG group-level interleaving is performed, the REG groups constituting each of the CCEs may be mapped to different REG bundles, so that the REG groups constituting each of the CCEs may be transmitted on the basis of different precoders.

On the other hand, the above-described interleaving method may be performed on a PRB basis. That is, REGs existing in the same PRB may be regarded as one REG group, and interleaving may be performed on a REG group basis. The PRB-level interleaving method may be used when the control resource set is composed of a plurality of symbols. The PRB-level interleaving may be performed as follows.

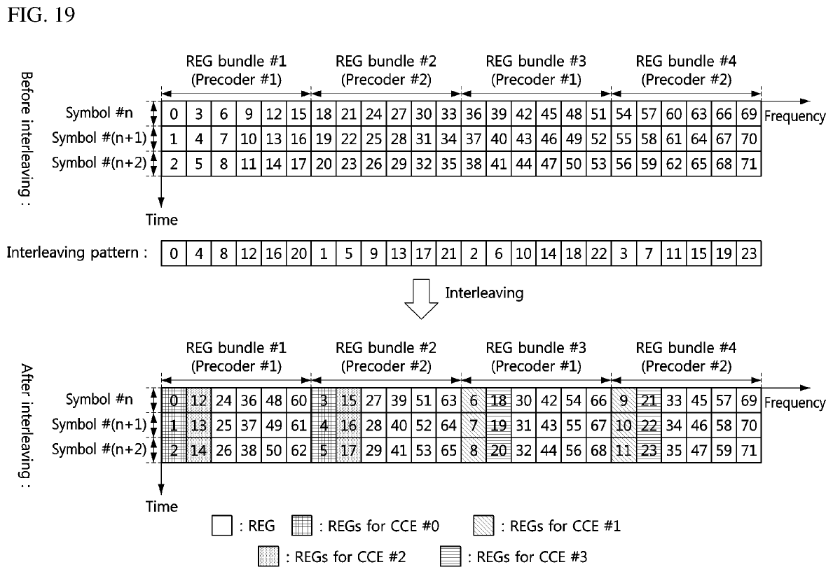

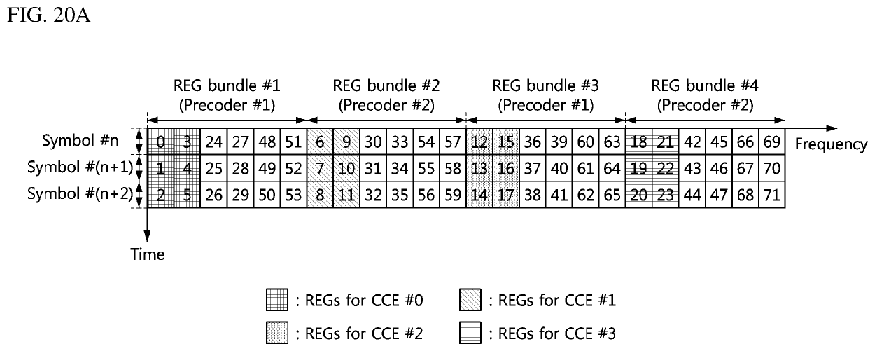

FIG. 19 is a conceptual diagram illustrating a first embodiment of a PRB-level interleaving method.

Referring to FIG. 19, a control resource set may be composed of 3 symbols in the time domain, and may be composed of 24 PRBs (e.g., 24 REGs) in the frequency domain. In this case, the number of REGs included in the control resource set may be 72, and the number K of REGs included in the CCE may be 6. The CCE-REG mapping may be performed based on the time-first mapping scheme. Here, the CCE-REG mapping may be performed based on two steps. In the first step of the CCE-REG mapping, the REG indexes (i.e., REGs #0 to #71) may be mapped to physical resources based on the time-first mapping scheme. The first step of the CCE-REG mapping may be the same as the embodiment of FIG. 3B.

In the second step of the CCE-REG mapping, the PRB-level interleaving may be performed. For example, REGs mapped to each of the symbols belonging to the control resource set may be permutated based on the same frequency interleaving pattern (e.g., the interleaving pattern according to Method 200 in FIG. 17). When the number of symbols belonging to the control resource set is and the interleaving pattern is X₀, X₁, . . . , and X_{M-1}, the REG indexes allocated in the frequency domain of the symbol #1 may be L×{X₀, X₁, . . . , X_{M-1}}+1. Here, 1 may be an integer equal to or greater than 0. When the control resource set (or search space) includes a plurality of symbols and a precoder cycling is applied, according to the PRB-level interleaving method, the REGs constituting each of the CCEs are mapped to the REG bundles as different as possible, so that the probability that different precoders are applied can be improved.

The REG group-level interleaving method may be effective when the wideband DMRS-based control resource set (or search space) overlaps with the narrowband DMRS-based control resource set (or search space) in the same time-frequency resource.

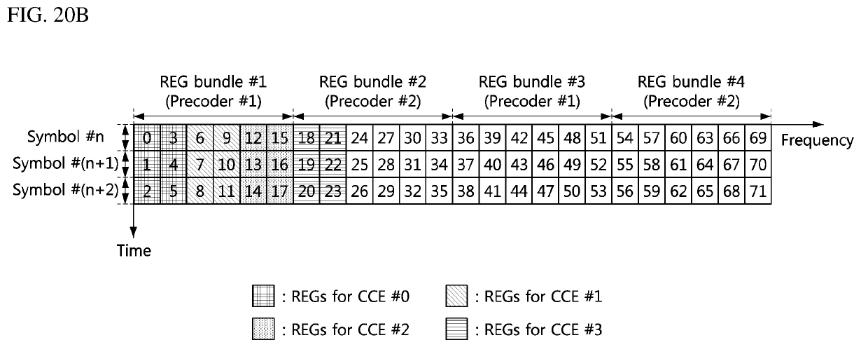

FIG. 20A is a conceptual diagram illustrating a first embodiment of a CCE-REG mapping method for a control resource set composed of 3 symbols, and FIG. 20B is a conceptual diagram illustrating a second embodiment of a CCE-REG mapping method for a control resource set composed of 3 symbols.

Referring to FIGS. 20A and 20B, a control resource set may be composed of 3 symbols in the time domain, and may be composed of 24 PRBs (e.g., 24 REGs) in the frequency domain. In this case, the number of REGs included in the control resource set may be 72, and the number K of REGs included in the CCE may be 6. The CCE-REG mapping may be performed based on the time-first mapping scheme, and 6 adjacent REGs may constitute one CCE. For example, the CCE #0 may include the REGs #6n to #(6n+5). Here, n may be an integer equal to or greater than 0.

When 2 REGs constituting the same CCE are consecutively configured in the frequency domain and the narrowband DMRS is mapped to the control resource set, channel estimation performance by REG bundling can be improved. In the embodiment of FIG. 20A, CCE-level frequency interleaving may be applied, and in the embodiment of FIG. 20B, CCE-level frequency interleaving may not be applied. In the embodiment of FIG. 20A, the CCE-level frequency interleaving may be performed on a REG group basis in the frequency domain of each of the symbols as in the embodiment of FIG. 19, and in the embodiment of FIG. 20A, the interleaving pattern may be equally applied to all symbols in the control resource set. Here, the interleaving unit (i.e., the size of the REG group in the frequency domain) may be 2.

Meanwhile, the control resource set configured according to FIG. 20A or 20B may be referred to as a ‘first control resource set’, and the control resource set configured according to Method 203 in the embodiment of FIG. 17 may be referred to as a ‘second control resource set’. When the first control resource set and the second control resource set are configured in the same frequency region, the second control resource set may be allocated in one symbol (e.g., symbol #n) among 3 symbols in which the first control resource set is allocated. In this case, the first control resource set may overlap with the second control resource set in the symbol #n.

For example, the first control resource set may be a terminal-specific search space based on narrowband DMRS, and the second control resource set may be a common search space based on wideband DMRS. In this case, when the CCE #0 is allocated to the second control resource set, the REGs (i.e., REGs #0 to #5) constituting the CCE #0 of the second control resource set are distributed in REG units in the frequency domain, so that the REGs constituting the CCE #0 of the second control resource set may be overlapped with the 6 CCEs of the first control resource set. In this case, the PDCCH may not be allocated to the 6 CCEs of the first control resource set overlapping the REGs constituting the CCE #0 of the second control resource set.

Further, the control resource set configured in accordance with Method 203 in the embodiment of FIG. 18 may be referred to as a ‘third control resource set’. When the first control resource group and the third control resource group are configured in the same frequency region, the third control resource set may be allocated in one symbol (e.g., symbol #n) among the 3 symbols in which the first control resource group is allocated. In this case, the first control resource set may overlap with the third control resource set in the symbol #n.

The third control resource set may be a wideband DMRS-based search space. When the CCE #0 is allocated to the third control resource set, the REGs (i.e., REGs #0 to #5) constituting the CCE #0 are distributed in REG group units in the frequency domain, and the REGs constituting the CCE #0 of the third control resource set may be overlapped with the 3 CCEs of the first control resource set. Since the interleaving unit of the third control resource set (i.e., 2 REGs) in the frequency domain is the same as the interleaving unit of the first control resource set, the number of CCEs overlapping in the first control resource set and the third control resource set may be reduced. Even when the wideband DMRS is mapped to the control resource set, if the REG group-level interleaving method is used, overlapping between the control resource sets to which different CCE-REG mapping schemes are applied can be minimized

In the embodiments described above, the size D of the REG group of the block interleaver may be configured to be equal to the size of the REG bundle in the frequency domain of the narrowband DMRS-based control resource set. The size of the REG bundle in the frequency domain of the wideband DMRS-based control resource set may be defined as an integer multiple of the size of the REG bundle in the frequency domain of the narrowband DMRS-based control resource set. For example, when the size of the REG bundle size is configured to 2 or 3 in the frequency domain of the narrowband DMRS-based control resource set, the size of the REG bundle size in the frequency domain of the wideband DMRS-based control resource set may be set to a common multiple of 2 and 3 (e.g., 6, 12, 24, . . . ).

Alternatively, when the size of the REG bundle in the frequency domain of the narrowband DMRS-based control resource set is 2, the size of the REG bundle in the frequency domain of the wideband DMRS-based control resource set may be a multiple of 2 (e.g., 4, 8, 16, . . . ). Alternatively, when the size of the REG bundle in the frequency domain of the narrowband DMRS-based control resource set is 3, the size of the REG bundle in the frequency domain of the wideband DMRS-based control resource set may be a multiple of 3 (e.g., 6, 12, 24, . . . ).

Methods 200 to 204 may be applied to all REGs allocated in the frequency domain of the control resource set. When the total number of REGs allocated in the frequency domain of the control resource set is not divided by the size of the REG bundle, it may be difficult to apply Methods 200 to 204. In this case, only some REGs among all REGs allocated in the frequency domain of the control resource set may be interleaved based on Methods 200 to 204. For example, when the control resource set includes 100 REGs in the frequency domain and the size of the REG bundle is 16, Methods 200 to 204 may be applied to 96 consecutive REGs in the frequency domain, and may not be applied to the remaining 4 REGs.

When the size of the REG bundle in the frequency domain is sufficiently larger than the bandwidth of the control resource set, as many precoders as possible may be applied to REGs constituting the CCE according to the interleaving methods (e.g., Methods 200 to 204) described above. When the size of the REG bundle in the frequency domain is small, the number of REG bundles in the frequency domain may be larger than the number of precoders used in the precoder cycling.

For example, when the control resource set includes N₁ REG bundles in the frequency domain and N₂ precoders are cyclically applied in REG bundle units in the entire frequency region of the control resource set, each of the precoders may be applied to (N₁/N₂) REG bundles. Here, N₂ may be a divisor of N₁. In this case, even when the above-described interleaving method (e.g., Methods 200 to 204) is applied, only a small number of precoders may be applied to REGs constituting a specific CCE. Therefore, the diversity gain can be reduced. A method for solving this problem may be as follows.

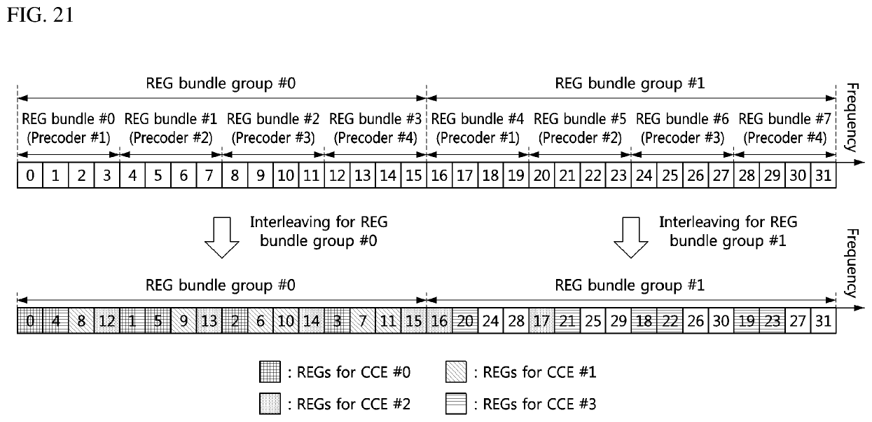

FIG. 21 is a conceptual diagram illustrating a first embodiment of an REG interleaving method according to Method 210.

Referring to FIG. 21, a control resource set may be composed of 1 symbol in the time domain, and may be composed of 32 PRBs (e.g., 32 REGs) in the frequency domain. The wideband DMRS may be mapped to the control resource set. The size of the REG bundle may be 4, and the number N₁ of REG bundles included in the control resource set may be 8. The number N₂ of precoders applied to the control resource set may be 4, and 4 precoders may be circularly applied on an REG bundle basis in the frequency domain of the control resource set. The precoder #1 may be applied to the REG bundles #0 and #4, the precoder #2 may be applied to the REG bundles #1 and #5, the precoder #3 may be applied to the REG bundles #2 and #6, and the precoder #4 may be applied to the REG bundles #3 and #7.

Method 210 may be a method of applying interleaving (e.g., Methods 200 to 204) to each of the (N₁/N₂) REG bundle groups. N₂ may be a divisor of N₁. The number of REG groups included in each REG bundle group may be N₂. That is, the number of REG groups included in each of the REG bundle groups may be configured to be equal to the number N₂ of the precoders. The number of REG groups included in each of the REG bundle groups may be predefined in the specification or may be configured by the base station.

The REG bundle group #0 may include the REG bundles #0 to #3, and may be interleaved based on Method 200. The REG bundle group #1 may include the REG bundles #4 to #7, and may be interleaved based on Method 200. The interleaving on the REG bundle groups #0 and #1 may be performed independently. Alternatively, the interleaving may be performed on each of the REG bundle groups #0 and #1 so that the REG indexes permuted by the interleaving are consecutively located at the boundary between the REG bundle groups #0 and #1. For example, when the last REG index belonging to the REG bundle group #0 after interleaving is #15, the first REG index belonging to the REG bundle group #1 may be set to #16. When the number of REGs included in each of the REG bundle groups #0 and #1 is not a multiple of the number of REGs constituting each of the CCEs, the corresponding CCE (e.g., CCE #2) may be mapped to a plurality of REG bundle groups.

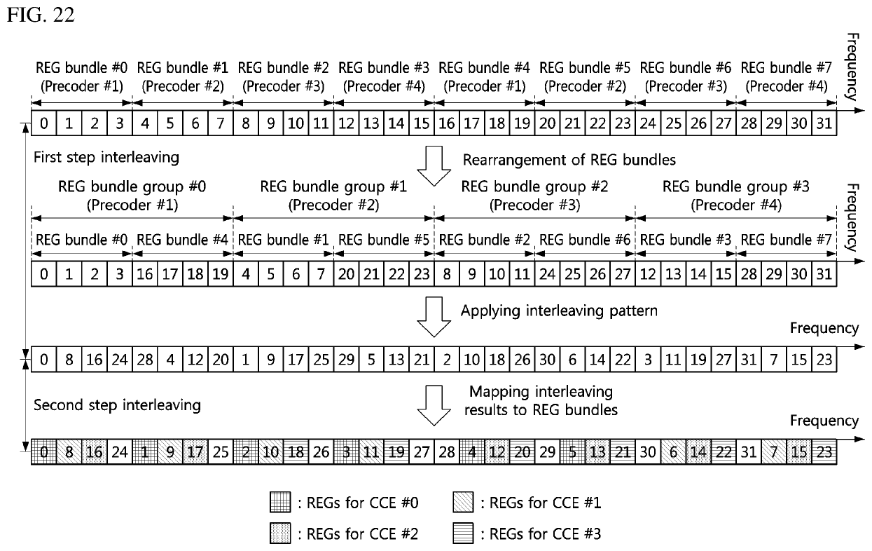

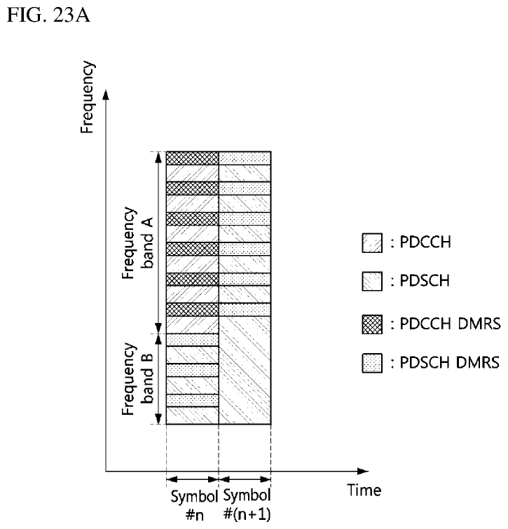

FIG. 22 is a conceptual diagram showing a first embodiment of an REG interleaving method according to Method 211.

Referring to FIG. 22, a control resource set may be composed of 1 symbol in the time domain, and may be composed of 32 PRBs (e.g., 32 REGs) in the frequency domain. The wideband DMRS may be mapped to the control resource set. The size of the REG bundle may be 4, and the number N₁ of REG bundles included in the control resource set may be 8. The number N₂ of precoders applied to the control resource set may be 4, and 4 precoders may be circularly applied on an REG bundle basis in the frequency domain of the control resource set.

The interleaving may be performed in 2 steps according to Method 211. In the first step of Method 211, the REG bundles to which the same precoder is applied may be configured as one REG bundle group, and the interleaving method described above (e.g., Methods 200 to 203) may be applied. In the first step of Method 211, N may be the number of REGs included in each of the REG bundle groups, and Q may be the number of REG bundle groups. That is, N may be 8, and Q may be 4.

Here, the REG bundle group #0 may include the REG bundles #0 and #4 to which the precoder #1 is applied, the REG bundle group #1 may include the REG bundles #1 and #5 to which the precoder #2 is applied, the REG bundle group #2 may include the REG bundles #2 and #6 to which the precoder #3 is applied, and the REG bundle group #3 may include the REG bundles #3 and #7 to which the precoder #4 is applied. The interleaving pattern in the first step of Method 211 may be the same as the interleaving pattern of Method 201.

In the second step of Method 211, the interleaving result of the first step may be mapped to the REG bundle. In this case, the location of the REG bundle to which the interleaving result of the first step is mapped may be the original location before the configuration of the REG bundle group. That is, a mapping rule for (interleaving result of first step REG bundle) in the second step of Method 211 may be the inverse of the mapping rule for (REG bundle REG bundle group) in the first step of Method 211. When Method 211 is completed, 4 precoders may be applied to all CCEs, and all CCEs may be distributed as much as possible in the frequency domain.

The number of REG bundles to which the same precoder is applied may be determined based on the number of precoders used for precoder cycling, the number of PRBs included in the control resource set, and the like. When Method 211 is performed, the base station may configure the number of REG bundles included in each of the REG bundle groups to the terminal. Alternatively, considering the signaling overhead, the number of REG bundles included in each of the REG bundle groups may be predefined as a fixed value. The number of REG bundles included in each of the REG bundle groups may be limited to a divisor of the total number of REG bundles in the frequency domain.

DMRS Sharing

The sequence used for the PDCCH DMRS may be a pseudo-noise (PN) sequence, a constant amplitude zero auto-correlation (CAZAC) sequence (e.g., Zadoff-Chu sequence), or the like. In the following embodiments, the PDCCH DMRS sequence may be a complex PN sequence based on a gold sequence used for a downlink reference signal and a synchronization signal in the LTE communication system. The generation of the gold sequence may be implemented through shift registers, and a plurality of pseudo-orthogonal sequences may be generated that are distinguished by a scrambling identifier by the shift registers. The cell-specific DMRS sequence may be generated based on a cell-specific scrambling ID, the terminal-specific DMRS sequence may be generated based on a terminal-specific scrambling ID, and the control resource set-specific DMRS sequence may be generated based on a control resource set-specific scrambling ID.

2 cell IDs (e.g., a physical cell ID and a virtual cell ID) may be used in the physical layer of the LTE communication system. The physical cell ID may be a unique ID for each cell or carrier. The number of physical cell IDs in the LTE communication system may be 504. On the other hand, the virtual cell ID may be used for coordinated multi-point (CoMP) transmission. Different physical cells may have the same virtual cell ID. Alternatively, a plurality of transmission points included in the same physical cell may have different virtual cell IDs. The NR communication system can support 1008 physical cell IDs. In the NR communication system, the base station can configure a separate ID (hereinafter referred to as a ‘scrambling ID’) that performs a similar function to the virtual cell ID in the terminal.

The PDCCH DMRS may be configured for each control resource set. When a plurality of search spaces are logically associated with one control resource set, the PDCCH DMRS configuration of the control resource set may be equally applied to each of the plurality of search spaces. Also, the PDCCH DMRS sequence may be a function of the physical cell ID or a function of the scrambling ID configured by the base station. The PDCCH DMRS sequence of the control resource set (e.g., control resource set #0) configured by the PBCH may be a function of the physical cell ID, and the PDCCH DMRS sequence of the control resource set configured by a remaining minimum system information (RMSI) or a system information block-1 (SIB-1) may be a function of the physical cell ID or a function of the scrambling ID configured by the base station. The PDCCH DMRS sequence of the control resource set configured by the terminal-specific RRC signaling may be a function of the scrambling ID configured by the base station.

In addition, the PDCCH DMRS sequence may be mapped to REs based on a specific frequency resource. In the case of the control resource set (e.g., control resource set with an index of 0) configured by the PBCH (or, master information block (MIB)) or the RMSI (or, SIB-1), the subcarrier #0 in the RB having the lowest index among common RBs belonging to the control resource set may be the specific frequency resource which is the starting point of the RE mapping. In the case of the control resource set configured by the terminal-specific RRC signaling, the subcarrier #0 in the common RB #0 may be the specific frequency resource which is the starting point of the RE mapping. In the case of the NR, the subcarrier #0 in the common RB #0 may mean a point A. The antenna port of the PDCCH DMRS may be distinguished from the antenna port of the PDSCH DMRS. In order to represent this, the antenna port number of the PDCCH DMRS may be defined as a value different from the antenna port number of the PDSCH DMRS.

Meanwhile, a terminal-specific DCI (e.g., DCI for downlink scheduling and DCI for uplink scheduling) may be transmitted based on a terminal-specific beamforming scheme like PDSCH. In this case, the PDCCH and the PDSCH transmitted in the terminal-specific search space may share the same DMRS antenna port(s) (hereinafter referred to as ‘Method 400’). The fact that the PDCCH and the PDSCH share the same DMRS antenna port may imply that a specific antenna port (e.g., antenna port 2000) of the PDCCH DMRS may be used for PDSCH demodulation and a specific antenna port (e.g., antenna port 1000) of the PDSCH DMRS may be used for PDCCH demodulation.

Also, the fact that the PDCCH and the PDSCH share the same DMRS antenna port means that a QCL relation is established between the antenna port of the PDCCH DMRS and the antenna port of the PDSCH DMRS, and that the terminal can assume the same precoder for the antenna port of the PDCCH DMRS and the antenna port of the PDSCH DMRS. In the following embodiments, it can be interpreted as described above that the antenna port of the PDCCH DMRS is identical to or logically associated with the antenna port of the PDSCH DMRS.

Method 400 may be applied when the PDCCH DMRS can be used for demodulating the PDSCH or when the PDSCH DMRS can be used for demodulating the PDCCH. In the common search space, the DCI may be transmitted using a terminal-specific beamforming scheme or the same beamforming scheme as that of the PDSCH. Accordingly, Method 400 may be equally applied to the terminal-specific search space as well as the common search space.

In the NR communication system, the locations of symbols to which the PDSCH DMRS is allocated may differ from case to case. When a slot-based PDSCH scheduling scheme is used, or when the PDSCH mapping type A is used, the location of the first symbol in which the PDSCH DMRS is located may be the third symbol or the fourth symbol in the slot. On the other hand, when a non-slot based PDSCH scheduling scheme is used or when the PDSCH mapping type B is used, the location of the first symbol in which the PDSCH DMRS is located may be the first symbol in the resource region in which the PDSCH is scheduled. In the following embodiments, the PDSCH mapping type B or the non-slot-based PDSCH scheduling scheme may be used unless otherwise noted.

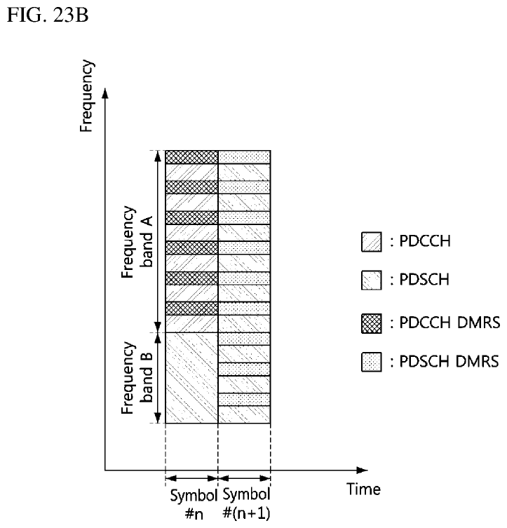

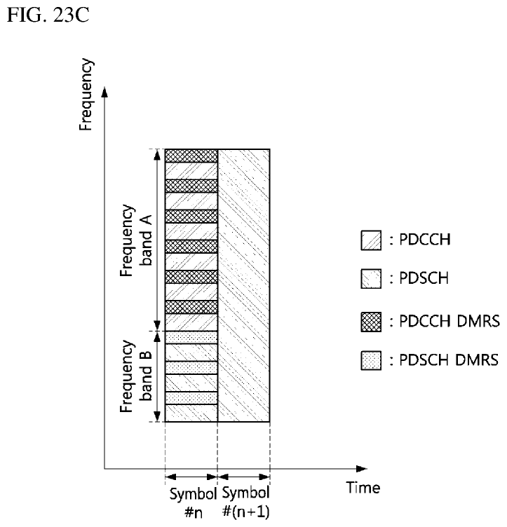

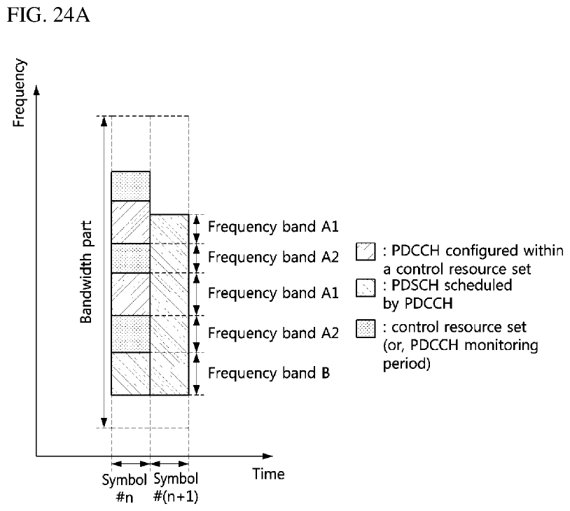

FIG. 23A is a conceptual diagram illustrating a first embodiment of a DMRS allocation method when a non-slot-based PDSCH scheduling scheme is used, FIG. 23B is a conceptual diagram illustrating a second embodiment of a DMRS allocation method when a non-slot-based PDSCH scheduling scheme is used, and FIG. 23C is a conceptual diagram illustrating a third embodiment of a DMRS allocation method when a non-slot-based PDSCH scheduling scheme is used.

Referring to FIGS. 23A to 23C, a PDSCH resource region may be composed of frequency bands A and B in the frequency domain, and may be composed of symbols #n and #(n+1) in the time domain. A PDCCH may be allocated in the PDSCH resource region. That is, the PDCCH may be overlapped with the PDSCH resource region. The PDCCH may be allocated to the symbol #n, and the PDSCH may be allocated to the symbols #n and #(n+1). The PDCCH may be allocated to the frequency band A in the symbol #n, and the PDSCH may be allocated to the frequency band B in the symbol #n. That is, the PDCCH may coexist with the PDSCH in the symbol #n. The PDSCH allocated to the symbols #n and #(n+1) may be scheduled by the PDCCH allocated to the symbol #n. The PDSCH may be rate-matched around the PDCCH. The PDCCH may be transmitted within a control resource set configured in the symbol #n. In the following embodiments, the control resource set may strictly refer to a monitoring occasion in a search space logically associated with the control resource set. In this case, according to the DMRS allocation method described above, the first symbol in which the PDSCH DMRS is allocated should be the symbol #n, but the PDSCH DMRS may not be allocated in the frequency band A in which the PDCCH is transmitted in the symbol #1 or the control resource set is configured. The embodiments of FIGS. 23A to 23C illustrate methods for solving this problem.

In the embodiment of FIG. 23A, the PDSCH DMRS may be allocated in the symbol #n in the frequency band B, and may be allocated in the symbol #(n+1) in the frequency band A. In the embodiment of FIG. 23B, the PDSCH DMRS may not be allocated in the symbol #n, and may be allocated in the frequency bands A and B in the symbol #(n+1). In the embodiment of FIG. 23C, the PDSCH DMRS may be allocated in the symbol #n in the frequency band B and not in the frequency band A. In this case, in order to demodulate the PDSCH allocated to the frequency band A, the PDCCH DMRS received through the frequency band A of the symbol #n may be used (hereinafter referred to as ‘Method 410’). Method 410 may be performed with Method 400.

Since the PDSCH and the PDCCH may be demodulated using the same DMRS (i.e., PDCCH DMRS) in Method 410, the terminal may use both a channel estimation value by the PDCCH DMRS and a channel estimation value by the PDSCH DMRS to demodulate the PDSCH received through the frequency bands A and B. Thus, Method 400 may be considered as a component of Method 410.

Since the DMRS overhead according to Method 410 is smaller than the DMRS overhead according to the embodiment of FIGS. 23A and 23B, the PDSCH reception performance can be improved through channel coding according to Method 410. Since the DMRS can only be transmitted in the first symbol (i.e., symbol #n) of the PDSCH in Method 410, the completion time of the channel estimation according to Method 410 may be earlier than the completion time of the estimation according to the embodiments of FIG. 23A and FIG. 23B. Therefore, since the channel estimation can be completed quickly according to Method 410, the PDSCH reception processing time can be reduced as compared with the embodiment of FIGS. 23A and 23B. On the other hand, Method 400 may be applied to the embodiments of FIGS. 23A and 23B. In this case, the channel coding gain is difficult to expect, and the PDCCH DMRS may be further used for the PDSCH demodulation, thereby improving the channel estimation performance

Method 410 may be effective when the size of transport block (TB) of the PDSCH is small and when the low latency requirements are high. Since a link performance is sensitive to an increase in code rate due to an increase in DMRS overhead as the size of TB is smaller, the link performance can be improved by the manner in which the PDCCH and the PDSCH share the DMRS port (i.e., Method 410). Since the completion time of channel estimation according to Method 410 is earlier than the completion time of channel estimation according to other methods, the PDSCH reception processing time can be reduced according to Method 410.

In the embodiments of FIGS. 23A to 23C, it has been considered that the frequency regions occupied by the PDCCH is contiguous and the PDSCH is rate-matched around the PDCCH rather than the control resource set. The following embodiments may be general cases as compared to the embodiments of FIGS. 23A to 23C.

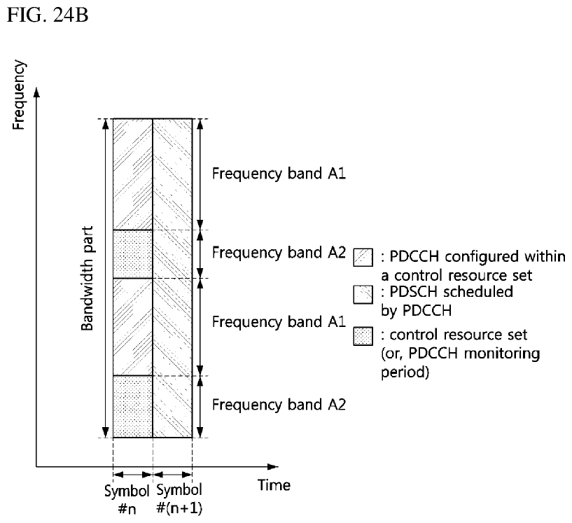

FIG. 24A is a conceptual diagram illustrating a first embodiment of a DMRS allocation method according to Method 410, and FIG. 24B is a conceptual diagram illustrating a second embodiment of a DMRS allocation method according to Method 410.

Referring to FIGS. 24A and 24B, the PDCCH may be allocated to the symbol #n and the PDSCH may be allocated to the symbols #n and #(n+1). Alternatively, the PDSCH may be allocated to the symbol #(n+1). In the embodiment of FIG. 24A, the PDSCH resource region may be composed of frequency bands A1, A2 and B in the frequency domain, and may be composed of the symbols #n and #(n+1) in the time domain. In the embodiment of FIG. 24B, the PDSCH resource region may be composed of frequency bands A1 and A2 in the frequency domain, and may be composed of symbols #n and #(n+1) in the time domain. The control resource set and the PDCCH may overlap with each other in the PDSCH resource region.

The PDSCH may be scheduled by the PDCCH. The PDCCH may be transmitted through some region of the control resource set, and the PDSCH may be rate-matched to the control resource set instead of the PDCCH. Also, the PDCCH may be mapped to two frequency chunks in the control resource set, and the PDSCH may be allocated to consecutive PRBs. In FIG. 24A, the PDSCH may be allocated to the frequency bands A1, A2 and B, and in FIG. 24b, the PDSCH may be allocated to the frequency bands A1 and A2.

The PDSCH DMRS may be allocated according to Method 410. The frequency bands in which the PDSCH is not allocated in the symbol #n may be the frequency bands A1 and A2. The frequency band A1 may be a frequency band in which the PDCCH for scheduling the PDSCH is transmitted, and the frequency band A2 may be a frequency band in which the PDCCH for scheduling the PDSCH is not transmitted. According to Method 410, since the PDCCH DMRS is transmitted in the frequency band A1, the PDSCH allocated to the frequency band A1 may be demodulated using the corresponding PDCCH DMRS. However, since the PDCCH DMRS is not transmitted in the frequency band A2, it may be difficult to demodulate the PDSCH allocated to the frequency band A2 using the PDCCH DMRS. Methods for solving this problem may be as follows.

As a first method, the wideband DMRS may be transmitted through a control resource set. When the DMRS (i.e., wideband DMRS) is transmitted through all the PRBs belonging to the control resource set, the PDCCH DMRS may be transmitted also in the frequency band A2. For this, Method 410 may be applied to the PDSCH scheduled through the wideband DMRS-based control resource set (or search space) (hereinafter referred to as ‘Method 420’).

On the other hand, the DMRS may not be transmitted through all the PRBs belonging to the control resource set. For example, the control resource set may comprise a plurality of frequency chunks, the plurality of frequency chunks may be discretely allocated in the frequency domain, and each of the plurality of frequency chunks may comprise consecutive PRBs. In this case, when the wideband DMRS-based control resource set is configured, the terminal may determine that the DMRS is transmitted through all the PRBs constituting the frequency chunk to which the received PDCCH is allocated, and that the DMRS is not transmitted through all the PRBs constituting the frequency chunk to which the received PDCCH is not allocated. Therefore, even when the control resource set in which the wideband DMRS is used is configured, the base station may not transmit the DMRS through some PRBs belonging to the control resource set according to the PDCCH mapping scheme. In this case, the frequency band A2 of FIGS. 24A and 24B may occur.

In order to solve this problem, the base station may allocate the control resource set or schedule the PDCCH so that the frequency band A2 does not occur. When Method 420 is used or when the PDCCH DMRS is reused for PDSCH demodulation similarly to Method 420, the terminal may not expect the frequency band A2 to occur. Alternatively, when Method 420 is used or when the PDCCH DMRS is reused for PDSCH demodulation similarly to Method 420, the terminal may assume that the PDCCH DMRS is transmitted through all the PRBs belonging to the control resource set. Alternatively, the terminal may assume that the PDCCH DMRS is transmitted through all the PRBs constituting the frequency chunk including at least one PRB to which the PDSCH is allocated among the frequency chunks constituting the control resource set.

As a second method, the terminal may rate-match the PDSCH around the PDCCH including the scheduling DCI instead of the control resource set (hereinafter referred to as ‘Method 421’). The base station may not configure the terminal to rate-match the PDSCH around the control resource set, and in this case, the terminal may rate-match the PDSCH around the PDCCH including the scheduling DCI. According to Method 421, the frequency band A2 may not occur. When Method 421 is used or when the PDCCH DMRS is reused for PDSCH demodulation similarly to Method 421, the terminal may not expect the frequency band A2 to occur. Alternatively, the terminal may use the method of reusing the PDCCH DMRS for PDSCH demodulation similarly to Method 410 or according to Method 410, only when the terminal is not configured to rate-match the PDSCH around the control resource set. Method 421 may be used even when the wideband DMRS is configured in the control resource set. In this case, the PDSCH may be rate-matched not only around the PDCCH including the scheduling DCI but also around the wideband DMRS.

In the above-described embodiments, it has been considered that the PDSCH is allocated to 2 symbols and the PDSCH is overlapped with the PDCCH or the control resource set in the first symbol to which the PDSCH is allocated. The above-described embodiments may be generalized to a case where the PDSCH is allocated to N symbols. Here, N may be an integer equal to or greater than 1. Also, the above-described embodiments may be generalized to a case where the PDSCH DMRS-mapped REs overlap with the PDCCH or the control resource set. When the PDSCH DMRS is allocated to the first and second symbols in the resource region to which the PDSCH is allocated, the PDSCH DMRS may be overlapped with the PDCCH or the control resource set in the second symbol as well as the first symbol. More generally, Method 410 may be used when at least one RE among the REs mapped to the PDSCH DMRS overlaps with downlink rate matching resources (i.e., resources configured not to be used for PDSCH transmission).

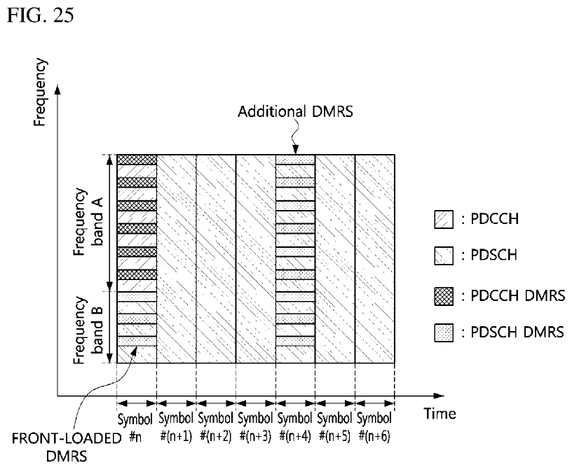

When Method 410 is used, the terminal may assume that the same precoder is applied to the PDSCH and the PDCCH (or PDCCH DMRS) allocated to each of the PRBs (or subcarriers) belonging to the frequency band A. That is, the REG bundling or the precoder granularity in the frequency domain applied to the PDCCH may be equally applied to the PDSCH. According to this method, when an additional DMRS is transmitted through a symbol other than the symbol through which the PDCCH is transmitted as in the frequency band A of FIG. 25, the REG bundle of the PDCCH DMRS may be different from the bundle of the PDSCH DMRS in the frequency domain. In order to solve this problem, the REG bundling for the PDCCH may be applied to the PDSCH instead of the PRB bundling for the PDSCH. That is, the same precoder as the PDCCH DMRS may be applied to the PDSCH and the PDSCH DMRS in each of the PRBs belonging to the frequency band A or the frequency band A1. Alternatively, a method using only PDSCH DMRS instead of Method 410 for PDSCH demodulation in the frequency band A or A1 may be considered. On the other hand, in the frequency region B, the same precoder may be applied to the PDSCH and the PDSCH DMRS in each of the PRBs.

FIG. 25 is a conceptual diagram illustrating a third embodiment of a DMRS allocation method according to Method 410.

Referring to FIG. 25, the PDCCH and the PDCCH DMRS may be transmitted in the symbol #n through the frequency band A, and the PDSCH and the PDSCH DMRS may be transmitted in the symbol #n through the frequency band B. The DMRS transmitted in the symbol #n may be referred to as a ‘front-loaded DMRS’. The PDSCH may be transmitted in the symbols #(n+1) to #(n+6) through the frequency bands A and B. The PDSCH DMRS may be additionally transmitted in the symbol #(n+4), and the PDSCH DMRS transmitted in the symbol #(n+4) may be referred to as an ‘additional DMRS’. The PDSCH allocated to the symbols #n to #(n+6) may be scheduled by the PDCCH allocated to the symbol #n.

Meanwhile, the base station may inform the terminal whether or not Method 410 is applied through an explicit or implicit signaling procedure. The explicit signaling procedure may be an RRC signaling procedure, a MAC signaling procedure, a physical layer signaling procedure, or the like. When the RRC signaling procedure is used, the application of Method 41 may be configured for each control resource set or for each search space. Alternatively, Method 410 may be applied only to a DCI format or a bandwidth part configured by the base station. For example, the base station may transmit URLLC data to the terminal using a specific control resource set, search space, DCI format, and/or bandwidth part, and may configure the terminal to apply Method 410 to the corresponding control resource set, search space, DCI format, and/or bandwidth part. When the implicit signaling procedure is supported, the terminal may use Method 410 for demodulating a PDSCH scheduled through a specific DCI format. For example, the specific DCI format may be a DCI format used for URLLC transmissions (e.g., DCI format 1_0 or a DCI format with a small payload size). In addition to Method 410, whether or not Method 400 is applied may be signaled to the terminal through the signaling procedure described above.

Method 410 may be used when a specific condition is met. For example, Method 410 may be used when the non-slot based PDSCH scheduling scheme or the PDSCH mapping type B is used. Alternatively, Method 410 may be used when the PDCCH scheduling PDSCH or the control resource set to which the PDCCH is allocated is completely included in the PDSCH resource region. Alternatively, Method 410 may be used when the number of PDCCH DMRS ports is equal to the number of PDSCH DMRS ports (e.g., when the number of PDCCH DMRS ports and the number of PDSCH DMRS ports are 1), or when the number of transmission layers of PDCCH DMRS is equal to the number of transmission layers of PDSCH DMRS (e.g., when the number of transmission layers of PDCCH DMRS and the number of transmission layers of PDSCH DMRS are 1). Alternatively, Method 410 may be used when the PDCCH and the PDSCH have the same QCL or the same transmit power is applied for transmission of the PDCCH DMRS and the PDSCH DMRS. Alternatively, whether or not Method 410 is applied may depend on at least one of the location of the starting symbol of the PDSCH, the number of symbols included in the PDSCH, the transport block size (TBS) of the PDSCH, and the overlapping type between the PDSCH and the PDCCH.

When Method 410 is used, the terminal may calculate the TBS considering Method 410. For example, when the PDSCH DMRS overhead in the frequency region A differs from the PDSCH DMRS overhead in the frequency region B, the terminal may calculate the TBS by properly considering the PDSCH DMRS overhead in both the frequency bands A and B. Alternatively, the terminal may calculate the TBS considering only the PDSCH DMRS overhead in the frequency band A or B.

Meanwhile, when a single-stage DCI is used, the PDCCH DMRS may be transmitted to the terminal through a single antenna port. On the other hand, since a signal-to-noise ratio (SNR) operation region of the PDSCH is higher than an SNR operation region of the PDCCH, it may be advantageous that the PDSCH DMRS is transmitted using multiple layers. Accordingly, both a single antenna port based PDSCH DMRS transmission and a multi-antenna port based PDSCH DMRS transmission may be supported.

Thus, when Method 410 is used, the PDSCH DMRS and the DMRS for the PDCCH scheduling the corresponding PDSCH may share the same Y antenna ports (hereinafter referred to as ‘Method 420’). Here, Y may be an integer equal to or greater than 1. The embodiment where Y is 1 may be defined as ‘Method 421’. For example, when Method 421 is supported and the PDSCH DMRS is transmitted through an antenna port #1000, the terminal may assume that an antenna port #2000 of the DMRS for the PDCCH scheduling the corresponding PDSCH is equal to the antennal port #1000 for the PDSCH DMRS. In this case, the terminal may use channel information estimated using the PDCCH DMRS for demodulation of the layer associated with the antenna port #1000 of the PDSCH DMRS.

Alternatively, when Method 421 is supported and the PDSCH DMRS is transmitted through antenna ports #1000 and #1001, the terminal may assume that the antenna port #2000 for the DMRS of the PDCCH scheduling the corresponding PDSCH is equal to the antennal port #1000 of the PDSCH DMRS. Alternatively, when Method 421 is supported and the PDSCH DMRS is transmitted through antenna ports #1002 and #1003, the terminal may assume that the antenna port #2000 for the DMRS of the PDCCH scheduling the corresponding PDSCH is equal to the antennal port #1002 of the PDSCH DMRS. When both the PDCCH DMRS and the PDSCH DMRS are transmitted through multiple antenna ports, Method 420 may be applied.

Method 420 and Method 421 may be used when the PDSCH is scheduled by a single-stage DCI. When a two-stage DCI is used, a first-stage DCI may include a part of PDSCH scheduling information and PDCCH scheduling information for transmitting a second-stage DCI, and the second-stage DCI may include remaining PDSCH scheduling information. The terminal may obtain the PDSCH scheduling information by receiving the first-stage DCI and the second-stage DCI. Method 420, Method 421, and the PDCCH/PDSCH DMRS sharing methods described above may be applied between the PDCCH including the second-stage DCI and the PDSCH scheduled by the corresponding PDCCH (i.e., second-stage DCI). For example, when the DMRS of the PDCCH including the second-stage DCI is transmitted through a single antenna port, the terminal may assume that the antenna port of the PDCCH DMRS is the same as a part of the antenna port(s) of the PDSCH DMRS.

When the PDSCH is transmitted through multiple layers (e.g., when the terminal uses multiple antenna ports for PDSCH demodulation), in order to support Method 420 or Method 421, the base station may use a signaling procedure to inform the terminal about the antenna port of the PDSCH DMRS which is the same as the antenna port of the PDCCH DMRS (hereinafter referred to as ‘Method 430’). For example, when the PDCCH DMRS uses the antenna port #2000 and the PDSCH DMRS transmitted through multiple layers uses the antenna ports #1000 and #1001, the base station may inform the terminal that the antenna port #2000 of the PDCCH DMRS is the same as the antenna port #1000 or #1001 of the PDSCH DMRS.

The precoding for the PDCCH DMRS may be determined as a precoding applied to one of the PDSCH DMRS ports based on the scheduling method, the channel state at the scheduling time, and the like. Thus, the signaling procedure in Method 430 may be a physical layer signaling procedure, and information on the sameness between the antenna port of the PDCCH DMRS and the antenna port of the PDSCH DMRS may be included in the DCI scheduling the PDSCH. In this case, in order to reduce the DCI overhead, only some antenna ports among the antenna ports of the PDSCH DMRS may be dynamically indicated by the DCI. For example, E antenna ports from the antenna port having the lowest number among the antenna ports of the PDSCH DMRS may be dynamically indicated by the DCI. E may be a natural number. E may be predefined in the specification. Alternatively, E may be configured in the terminal through a higher layer signaling procedure. When the sameness between the antenna port of the PDCCH DMRS and the antenna port of the PDSCH DMRS is configured semi-statically, information on the sameness between the antenna port of the PDCCH DMRS and the antenna port of the PDSCH DMRS may be configured in the terminal through a higher layer signaling procedure (e.g., RRC signaling procedure).

For Method 420 or Method 421, mapping information (e.g., sameness information) between the antenna port of the PDCCH DMRS and the antenna port of the PDSCH DMRS may be predefined in the specification (hereinafter referred to as ‘Method 431’). The terminal may assume that the antenna port of the PDCCH DMRS is the same as the antenna port having the lowest number among the antenna ports of the PDSCH DMRS. For example, the PDCCH DMRS is transmitted through the antenna port #2000 and the PDSCH DMRS is transmitted through the antenna ports #1000 and #1001, the terminal may assume that the antenna port #2000 of the PDCCH DMRS is equal to the antennal port #1000 of the PDSCH DMRS. According to this method, in the above-described embodiment, a separate signaling procedure may not be required for sharing between the antenna port of the PDCCH DMRS and the antenna port of the PDSCH DMRS.

The embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

1. A method for receiving a downlink signal, performed by a terminal (user equipment (UE)) in a communication system, the method comprising:
receiving a control demodulation reference signal (DMRS) for a downlink control channel from a base station in a time-frequency resource region #1;
performing demodulation and decoding operations on the downlink control channel in the time-frequency resource region #1 by using channel estimation information #1 based on the control DMRS;
performing demodulation and decoding operations on a downlink data channel by using the channel estimation information #1 in a frequency band A in a time-frequency resource region #2 indicated by scheduling information obtained from the downlink control channel; and
performing demodulation and decoding operations on the downlink data channel in a frequency band B in the time-frequency resource region #2 by using channel estimation information #2 based on a data DMRS received in the frequency band B,
wherein a frequency band of the time-frequency resource region #1 includes the frequency band A, and a frequency band of the time-frequency resource region #2 includes the frequency bands A and B.

2. The method according to claim 1, wherein the downlink control channel is received in a control resource set or a physical downlink control channel (PDCCH) search space.

3. The method according to claim 1, wherein a number of antenna ports for the control DMRS is equal to a number of antenna ports for the data DMRS.

4. The method according to claim 1, wherein a number of transmission layers for the control DMRS is equal to a number of transmission layers for the data DMRS.

5. The method according to claim 1, wherein a rate matching operation around the downlink control channel is performed to receive the downlink data channel

6. The method according to claim 1, wherein information indicating that the control DMRS is used for demodulating the downlink data channel is received through a signaling from the base station.

7. The method according to claim 1, wherein the control DMRS is allocated in the frequency band A of at least one symbol commonly included in the time-frequency resource region #1 and the time-frequency resource region #2, and the data DMRS is allocated in the frequency band B of the at least one symbol.

8. The method according to claim 1, wherein, when a time period of the time-frequency resource region #2 is composed of M symbols, additional data DMRS for the downlink data channel is received in an i-th symbol among the M symbols, each of M and i is an integer equal to or greater than 2, and i is equal to or less than M.

9. The method according to claim 8, wherein a precoding applied to the additional data DMRS is identical to a precoding applied to the control DMRS in each of physical resource blocks (PRBs).

10. A method for receiving a downlink signal, performed by a terminal (user equipment (UE)) in a communication system, the method comprising:
receiving a control demodulation reference signal (DMRS) from a base station in a time-frequency resource region #1 configured for a control resource set;
performing demodulation and decoding operations on a downlink control channel in the time-frequency resource region #1 by using channel estimation information #1 based on the control DMRS; and
performing demodulation and decoding operations on a downlink data channel by using the channel estimation information #1 in a time-frequency resource region #2 indicated by scheduling information obtained from the downlink control channel,
wherein the time-frequency resource region #1 overlaps with the time-frequency resource region #2, a frequency band of the time-frequency resource region #1 includes frequency bands A1 and A2, the control DMRS is received in the frequency bands A1 and A2, and the downlink control channel is received in the frequency band A1.

11. The method according to claim 10, wherein the control DMRS is a wideband DMRS transmitted through an entire frequency band of the control resource set.

12. The method according to claim 10, wherein the downlink control channel is received through some time-frequency resource region in the control resource set.

13. The method according to claim 10, wherein a rate matching operation is performed around the downlink control channel or the control resource set to receive the downlink data channel.

14. The method according to claim 10, wherein information indicating that the control DMRS is used for demodulating the downlink data channel is received through a signaling from the base station.

15. A method of transmitting a downlink signal, performed by a base station in a communication system, the method comprising:
transmitting a downlink control channel, a control demodulation reference signal (DMRS), and a downlink data channel #1 in a frequency band A; and
transmitting a downlink data channel #2 and a data DMRS in a frequency band B,
wherein the control DMRS is used for demodulating the downlink control channel and the downlink data channel #1 transmitted in the frequency band A, and the data DMRS is used for demodulating the downlink data channel #2 transmitted in the frequency band B.

16. The method according to claim 15, wherein a number of antenna ports for the control DMRS is equal to a number of antenna ports for the data DMRS.

17. The method according to claim 15, wherein a number of transmission layers for the control DMRS is equal to a number of transmission layers for the data DMRS.

18. The method according to claim 15, wherein a rate matching operation is performed around the downlink control channel to transmit the downlink data channels #1 and #2.

19. The method according to claim 15, wherein information indicating that the control DMRS is used for demodulating the downlink data channel #1 is transmitted through a signaling of the base station.

20. The method according to claim 15, wherein additional data DMRS used for demodulating the downlink data channels #1 and #2 are transmitted in the frequency bands A and B.
